(19) United States
(12) Patent Application Publication
(10) Pub. No.: US 2013/0219481 A1
(43) Pub. Date: Aug. 22, 2013

(54) Cyberspace Trusted Identity (CTI) Module

(71) Applicant: Robert Matthew Voltz, Lansdowne, VA (US)

(72) Inventor: Robert Matthew Voltz, Lansdowne, VA (US)

(21) Appl. No.: 13/744,369

(22) Filed: Jan. 17, 2013

Related U.S. Application Data
(60) Provisional application No. 61/599,560, filed on Feb. 16, 2012.

(51) Int. Cl. H04L 29/06

(52) U.S. Cl. CPC H04L 63/0861
USPC 726/9

(57) ABSTRACT

The Cyberspace Trusted Identity (CTI) module provides secure storage of a cyberspace user's personal identity information and a security infrastructure to guarantee the integrity and privacy of a cyberspace transaction. When the owner of an electronic device registers their biometric samples on the CTI module the module becomes locked and the information stored on the module can only be accessed when the device owner provides a live biometric sample, which matches the registered biometric sample. When the CTI Module is registered under a trusted third party system; a Cyberspace Identification Trust Authority (CITA) system, the module provides a secure mechanism for storing a cyberspace user's digital identity tokens and for conducting safe and reliable cyberspace transactions between two cyberspace users. The CTI Module eliminates the need to carry man-made identity tokens, or the need to remember and/or openly exchange personal identity information, when conducting a cyberspace transaction.

### CROSS REFERENCE TO RELATED APPLICATIONS

This Patent Application is related to Provisional Patent Application # 61/599,560, Provisional Patent Application # 61/602,431, and Trademark Application # 85552808, all herein incorporated by reference. A Notice of Allowance (NOA) for Trademark Application # 85552808 was issued by the USPTO on Oct. 2, 2012 and CITA is now a registered trademark of REV Incorporated.

A security module; the Cyberspace Trusted Identity (CTI) Module, implemented on an electronic device and supporting data encryption and digital signatures operations, secure storage of digital identity tokens, and owner authentication through multi-modal biometric identification, provides for the establishment of trusted cyberspace identities and the secure processing of cyberspace transactions.

### STATEMENT REGARDING FEDERALLY SPONSORED RESEARCH OR DEVELOPMENT

N/A

### BACKGROUND OF INVENTION

Today's world faces an abundance of increasingly sophisticated attacks against personal, sensitive, financial, and confidential information held by Cyberspace users. The cases of identity theft and fraudulent transactions within the electronic commerce, retail, and other business segments; coupled with attacks and invasion of on-line systems providing access to web portals or support to critical infrastructure services, such as gas, electric, or water utilities, are increasingly common. As additional commercial and government cyberspace service providers become available to cyberspace users, both in the retail environment and the on-line environment, the amount of sensitive information transmitted between two cyberspace parties will only increase, as will the increased probability of financial and personal loss associated with identity theft, data theft, and privacy breaches.

In today's electronic commerce world a cyberspace user is often required to provide sensitive financial account information, e.g., providing a credit card to be processed by a local retailer for services rendered or providing a financial account number to make payments for an order placed on-line. Such information is not adequately safeguarded once the information is provided to the intended cyberspace service provider. The current systems and methodologies in place today to protect cyberspace users and financial institutions are unfortunately fraught with numerous opportunities for identity theft and fraudulent transactions, the cost of which is ultimately transferred to the consumer of the cyberspace service. Financial institutions recovery their loss through increased late fees and over-limit fees on credit accounts established by cyberspace users and service providers recover their loss of profit from fraudulent transactions or the cost of doing business in the e-commerce world through the increased cost of goods/services provided. In 2011 the on-line revenue loss to service providers due to fraudulent transactions alone was estimated at $3.48.¹ ¹ Cybersource, 13^{th} Annual Online Fraud Report, 2012 Online Fraud Report, Web: www.cybesource.com.

This increased debt to cyberspace users is brought about by a current methodology that fails to protect cyberspace user personal identity attributes and financial account information accurately and securely. While the total amount of losses, both financial and personal, due to online fraud and identity theft are difficult to measure, the problem is genuine and increasing on an annual basis². In addition, a cyberspace service provider's retail environment and/or their internet site often does not provide a secure environment for cyberspace users to request or utilize the provider's services, as cyberspace users have limited ability to manage or protect their personal information once it is released to a service provider. As a result, the cyberspace user is often forced to make a trade-off, between the increased risk of identity theft and the desire to easily and comfortably utilize the cyberspace service they desire. Likewise, cyberspace service providers must often trade the increased risk of fraud against the ability to expand their service offering in an online environment. ² The 2009 Internet Crime Report states, “From Jan. 1, 2009, through Dec. 31, 2009, the Internet Crime Complaint Center (IC3) Web site received 336,655 complaint submissions. This was a 22.3% increase as compared to 2008. The total dollar loss from all referred cases was $559.7 million, up from $264.6 million in 2008. “2009 Internet Crime Report ” Internet Crime Complaint Center IC3, 12 Mar. 2010, p 14, Web: 2 Jun. 2010, http://www.ic3.gov/media/annualreport/2009_IC3Report.pdf

Over 10 million Americans are victims of identity theft each year—“The Department of Justice's Efforts to Combat Identity Theft”—U S Department of Justice, Office of the Inspector General, Mar 2010 Web: 2 Jun. 2010 http://www.justice.gov/oig/reports/plus/a1021.pdf.

A Federal Trade Commission survey found that victims of identity theft can spend more than 130 hours reconstructing their identities (e g, credit rating, bank accounts, reputation, etc) following an identity crime—“2006 Identity Theft Survey Report” Federal Trade Commission Nov 2007, p 6, Web: 2 Jun. 2010 http://www.ftc.gov/os/2007/11/SynovateFinalReportIDTheft2006.pdf.

Furthermore, cyberspace users have a limited ability to utilize secure identities across multiple cyberspace services because many of the web portals offered through service providers do not use a common enterprise security framework. Instead, the cyberspace user is faced with the increasing responsibility, complexity, and inconvenience associated with managing multiple user accounts and passwords, and other identity attributes required to obtain or conduct services online and across dissimilar cyberspace service providers. Finally, the collection of a cyberspace users' identity-related information across multiple cyberspace service providers, coupled with the sharing of personal information through the wonder of the social media phenomenon, only serves to increase the likelihood for data compromise and privacy breeches. Together, these vulnerabilities of the current environment leads to further opportunities of cybercrime as on-line hackers continue to penetrate on-line service providers and end cyberspace users to illegally obtain user account and password information.

The current trend in the credit/debit card industry to address identity theft places the emphasis on the use of Near Field Communication (NFC) technology. This technological approach employs the use of “smart credit cards” that utilize smart card technology with an embedded computer chip supporting the ability to transmit payment information from the physical credit card to a payment terminal using radio frequency (RF) capabilities. NFC standards cover communications protocols and data exchange formats, and are based on existing radio-frequency identification (RFID) standards including ISO/IEC 14443. Thus, with the use of NFC a consumer is no longer required to physically provide the actual card to the service provider (thereby reducing the probability of unknowingly releasing their financial account information to a potential identity theft criminal) as the financial account information is automatically transferred to the payment terminal through RF mechanisms as the consumer passes the card over the payment terminal's RF reader, or in some cases, is in close proximity to a payment terminal that incorporates NFC technology. The smart phone industry seems to be following this trend as the availability of NFC technology within smart phones is also on the rise. The Android OS currently supports NFC capabilities and Apple, Samsung, and RIM will be soon be incorporating NFC capabilities into their latest smart phone offerings.

Why is the use of NFC technology the wrong approach? First, the deployment of NFC technology to many service providers may be cost prohibitive as it requires the service provider to have a payment terminal that can accept an NFC-based transaction. This limits the availability of service provider locations that will even support NFC technology. On top of that, the approach is based solely on the retail point-of-sale transaction, where the consumer presents the physical card to the service provider. NFC does nothing to address on-line cybercrimes where the consumer unknowing provides financial account information to an untrustworthy web site where the account information can be readily available for the cybercrime professional to obtain. Secondly, and most importantly, the NFC capability does not protect against Man-in-the-Middle attacks where a portable RF reader can be utilized by a cybercrime professional to obtain the financial account information as it is passed from the consumer to the service provider. While the communication range of NFC is limited to a few centimeters, NFC alone does not ensure secure communications. Thus, a cybercriminal's eavesdropping device only has to be in the same proximity of the payment terminal reader as the data exchange is not protected through a Public Key Infrastructure (PKI) mechanism and/or data encryption methodologies. While industry has recommended that NFC incorporates data encryption and PKI methodologies the current ISO standard, upon which NFC is based, does not support these capabilities. Implementing PKI and data encryption capabilities requires a safe and reliable storage location for the protection of the secret keys used to implement such an infrastructure, and the current technology employed in today's market does not support such a capability.

An alternative approach to NFC vulnerabilities is to employ these data security capabilities at the application layer, where cryptographic protocols, e.g., Secure Socket Layer (SSL) can be utilized to establish a secure channel, but the approach proves to be unfeasible and cost prohibitive due to the complexity of establishing a mutually authenticated connection. Mutual authentication requires both the sending party and the receiving party to mutually authenticate each other through the exchange of digital certificates and by far provides the highest level of trusted and secure communications. But, implementing such an approach would require both the payment terminal and the physical card to store digital certificates for every possible payment transaction they will ever encounter, which is simply not possible.

A fundamental problem with the current e-commerce environment is the payment vehicle itself; the credit/debit card. Why does a consumer need to have in his/her possession a physical card that is susceptible to being lost or stolen? This man-made token is mass produced by financial institutions around the world and issued to millions of card holders on an annual basis. Consequently, the vulnerability of gaining access to a consumer's financial account information is only amplified, as little or no safeguards can be added to the physical card in a cost efficient manner to safeguard the financial account information readily displayed on the physical card. Prior attempts to safeguard the physical card have included the use of a digital photo of the card holder, which is intended to be verified by the service provider upon accepting the card. While the solution (when utilized as a standard norm of point-of-sale business practices) can deter the use of stolen cards, it does nothing to address on-line cybercriminals using the same level of financial account information from stolen cards.

Personal Identification Numbers (PIN) have also been used to safeguard the use debit cards for years, and with some level of success, but the cost of manufacturing these cards and the administrative burden of managing PINs is pushed back upon the consumer. In addition, successful hacking methodologies to gain access to consumer PIN information and/or reproducing counterfeit cards have also established vulnerabilities under this approach. The introduction of the Card Security Code (CSC), also referred to as the Card Verification Data (CVD), Card Verification Value (CVV or CVV2), Card Verification Value Code (CVVC), Card Verification Code (CVC or CVC2), Verification Code (V-Code or V Code), or Card Code Verification (CCV), was an attempt to address on-line fraud, but while the capability has proven effective in reducing fraudulent transaction rates the approach is still susceptible to being compromised as the code itself is still readily available from the physical card and in many cases can be obtained through the hacking of on-line financial institutions and/or service providers that maintain the information.

Alternative solutions seeking to address the vulnerabilities of present day card technology and to overcome the fraudulent attempts of using stolen and/or counterfeited cards relies upon the use of smartcard technology combined with biometrics and/or a PIN. Smartcards, when implemented properly, provide a somewhat safe and reliable approach to providing secure storage of secrets keys used for data encryption, and digital signature operations, and under these solutions the identity of a consumer is confirmed and a biometric sample is captured from the consumer and physically stored on the smartcard. In order to use the card the consumer must authenticate their identity by providing a live biometric sample, which can then be compared to the biometric sample stored on the card. If higher level of authentication is required the user must also present the associated card PIN. If the biometric samples (and PIN) are matched the consumer is confirmed to be the valid owner of the card and access to the embedded PKI infrastructure and the use of the card can be approved. While various biometric modalities. i.e., fingerprint, iris, face, etc., have been deployed under these proposed solutions the approach itself still presents vulnerabilities. First, because the biometric samples and PIN are electronically stored they are susceptible to being reproduced if not adequately safeguarded through PKI and data encryption methodologies. Second, because the verification matching process can be performed through an applet stored within the card chip, which can be altered if not adequately safeguarded, the identity verification approach is independent and outside the direct control of the service provider attempting to confirm the identity of the card holder. Lastly, if the control of the verification matching process is assigned to the service provider the solution becomes cost prohibitive as all service providers will now have to support and integrate additional hardware/software capabilities into their present day POS systems to support the use of these smart cards.

Examples of these approaches to overcoming physical card vulnerabilities and using biometric identification/PIN technology coupled with a physical card are described under the following patents; U.S. Pat. No. 4,821,118 (Lafreniere); U.S. Pat. No. 4,993,068 (Piosenka et al.); U.S. Pat. No. 4,995,086 (Lilley et al.); U.S. Pat. No. 5,054,089 (Uchida et al.); U.S. Pat. No. 5,095,194 (Barbanell); U.S. Pat. No. 5,109,427 (Yang); U.S. Pat. No. 5,109,428 (Igaki et al.); U.S. Pat. No. 5,144,680 (Kobayashi); U.S. Pat. No. 5,146,102 (Higuchi et al.); U.S. Pat. No. 5,180,901 (Hirainatsu); U.S. Pat. No. 5,210,588 (Lee); U.S. Pat. No. 5,210,797 (Usui et al.); U.S. Pat. No. 5,222,152 (Fishbine et al.); U.S. Pat. No. 5,280,527 (Gullman et al.); U.S. Pat. No. 5,230,025 (Fishbine et al.); U.S. Pat. No. 5,241,606 (Horie); U.S. Pat. No. 5,265,162 (Bush et al.); U.S. Pat. No. 5,321,242 (Heath, Jr.); U.S. Pat. No. 5,325,442 (Knapp); and U.S. Pat. No. 5,351,303 (Willmore).

The example patents cited above utilize biometric technology in combination with smart cards and/or common every day credit/debit card technology. Thus, the consumer is still required to carry and present a physical card in order to authenticate their identity and/or ownership of the card. While these approaches still carry the burden on the consumer to physically possess the card in order to carry out a service transaction successfully, they also carry the additional burden of being cost prohibitive when the cost of the card technology (a PIN and/or biometric based smartcard cost on the order of $5), coupled with the cost of the enterprise infrastructure required to support such an approach (POS systems require the ability to read and interpret smartcard and possibly the ability to capture biometric samples) are taken into consideration. With over 100 M current card holders and over 5 M POS terminals operational (in the US alone) the cost of deploying such a solution (and making it readily available to consumers everywhere) quickly exceeds the current annual estimates of revenue loss due to fraudulent transactions. As with the above cited examples, these additional costs burdens would ultimately be passed on to the consumer through higher fees associated with the use of these approaches.

The industry has also explored the use of biometrics through “token-less” based approaches to addressing fraudulent transactions and identity theft, as evidenced under U.S. Pat. No. 7,536,352 B2 (Lapsley et al.), U.S. Pat. Appl. 20070291996 (Hoffman et al.), and U.S. Pat. Appl. 20020019811 (Lapsley et al.). Under these solutions the consumer registers with a third party system to enroll a sample biometric under an assigned unique PIN. The consumer's registration process also requires the consumer to identify a financial account upon which funds are drawn to make payment on approved service transactions. Service providers using this approach are also required to register with the third party system and under some of these proposed inventions assign a unique PIN to the service provider as well, in addition to requiring the service provider to designate a financial account to receive consumer payments. Under these “token-less” based approaches the consumer and service provider complete payment for a service transaction when the consumer uses an electronic device at the POS terminal to enter their PIN and capture a live biometric sample, which is then submitted (together with other information relating to the transaction, i.e., the service provider's PIN, the amount of the service transaction, etc.) to the third party system for approval. The third party system in turn compares the consumer's live biometric sample to their registered biometric sample to authenticate their identity and in so doing initiates completion of the financial transaction by transferring funds from the consumer's account to the service provider's account.

While the use of a third party system under these proposed inventions is a valid approach to establishing a root of trust, and the proposed inventions successfully remove the credit/debit card “token” from the equation, they still exhibit limitations and vulnerabilities disclosed under the previously addressed solutions. For example, it remains the burden of the consumer to always remember their PIN, as without it they are unable to even initiate a transaction. As well, the solutions require access to an electronic device at the POS terminal that supports the ability to communicate with a third party system, capture a consumer's PIN, and more importantly capture a consumer's live biometric sample. As stated earlier placing such a device at POS terminal locations would be cost prohibitive and ultimately passed on to the consumer to burden. But most importantly, none of the cited examples address the need to safeguard the information exchanged between the service provider, consumer, and the third party system. As the use of PKI methodologies and data encryption technology are not incorporated into these inventions the proposed solutions still suffer the vulnerability of man-in-the-middle attacks and accessibility to consumer private information by cybercriminals without these safeguards in place. The main reason for this limitation is the offered solutions do not support a safe and reliable mechanism for securely storing the secret keys that are required to support a PKI infrastructure for data encryption and digital signature operations. Lastly, the solutions rely upon a third party system that can support real-time biometric identification matching capabilities in order to complete the transaction in a timely manner. Such a solution could also be cost prohibitive to implement (considering the need for the POS devices to support such a capability and the additional network bandwidth capacity required to transmit biometric records between the consumer/service provider and the third party system), outside the fact that delayed service capabilities with transmitting these larger amounts of data and the time for the third party system to conduct the biometric matching service would result in further delays with completing the POS transaction.

Under these existing inventions the need to perform a biometric authentication of identity is required on a transaction-by-transaction basis and the operation is either performed through a specialized POS device or a third party system. While using biometric identification technology is a valid approach to establishing and authenticating a cyberspace user's identity, the existing inventions are limited to performing this operation every time a cyberspace transaction is conducted because these existing inventions do not provide a mechanism to securely store and re-use a trusted identity credential once established. As previously discussed, smart cards have been employed by other inventions to securely store identity credentials, but the use of this technological approach requires the cyberspace user to always have the smart card in their possession, is susceptible to being lost or stolen, and is costly to implement and maintain.

As a result of these existing vulnerabilities and limitations in the cyberspace world there is a need for a new innovative approach that supports secure storage of established identity credentials and provides the ability to conduct safe and reliable cyberspace transactions, all from a cyberspace user's existing electronic device. While this new approach still relies upon the use of a third party system to establish a root of trust for cyberspace identities, the established identity credential, once created by the third party system, can be securely stored on a cyberspace user's electronic device through the use of a new innovative security module; the Cyberspace Trusted Identity (CTI) Module. Incorporating PKI methodologies; data encryption and digital signature mechanisms; multi-modal biometric identification technology; and secure storage capabilities on such a security module eliminates the need for cyberspace users to carry in their possession a man-make identity token. It eliminates the needs for cyberspace users to openly exchange personal identity attributes as trusted identity attributes can be passed between the service provider and consumer in an encrypted format, which is digitally signed by a trusted third party system. It also eliminates the need for the consumer to remember and ever expanding list of user Ids, passwords, account numbers, etc., as these identity credentials can be maintained in an encrypted format within the secure storage repository on the security module. Lastly, this new innovative approach eliminates the need for a cyberspace service provider to provide specialized devices to authenticate a cyberspace users' identity.

As such, the benefits of the innovative approach presented herein for providing secure storage of established identity credentials and for providing a security infrastructure for conducting trusted and safe cyberspace transactions far outweighs the significant list of limitations present in today's internet and retail environments. By introducing a new innovative approach to address these vulnerabilities and limitations the prevalent cases of fraud and privacy infringements, coupled with the increased inefficiencies placed upon the cyberspace user and service provider to authenticate identities, can be greatly reduced and/or eliminated. In addition, the ability for cyberspace users to mutually trust each others' identities, together with the ability to make electronic payments easily and securely, will help to increase the economic efficiencies of service providers as more consumers establish trust in using their services, as well as reduce the cost of goods/services provided, which ultimately benefits the consumer who has suffered the burden of paying for the limitations in the current cyberspace environment.

Accordingly, an objective of this invention is to provide a new security module; the Cyberspace Trusted Identity (CTI) Module, which can be coupled with a cyberspace user's electronic device to conduct safe and reliable cyberspace transactions.

Another objective of the invention is for said security module to provide a security infrastructure, comprising; PKI methodologies, data encryption, hashing, and digital signature mechanisms. This objective serves to facilitate the conduct of safe and reliable cyberspace transactions by ensuring the privacy and integrity of the transaction.

Another objective of the invention is for said security module to incorporate a unique Private/Public key pair, which is assigned to the module at time of manufacturing, securely stored on the module, and subsequently used for performing data encryption and digital signature operations performed on the module.

Another objective of the invention is for said security module to incorporate a unique device identification number, such that cyberspace digital identities tokens processed by the security module can be uniquely identified as belong to and/or originating from the security module.

Another objective of the invention is for said security module to provide for secure storage of a device owner's identity attributes, to include personal information, financial account information, medical account information, membership account information, and any other data elements a cyberspace user may utilize in conducting a cyberspace transaction, or desire to maintain in a secure environment.

Another objective of the invention is for said security module to provide for secure storage of established cyberspace user digital identity tokens. This objective ensures that digital identity tokens, once generated and stored on the security module, cannot be compromised.

Another objective of the invention is for said security module to employ multi-modal biometric identification technology and the ability to register a device owner's live biometric samples to the security module.

Another objective of the invention is for said security module to utilize multi-modal biometric identification technology as a mechanism for safeguarding access to the module. This objective ensures that access to the security module is only granted after a live biometric sample is authenticated, i.e., biometrically matched, against the corresponding biometric sample registered on said security module.

Another objective of the invention is for said security module to support secure interfaces to third party applications provided by Cyberspace Identification Trust Authority (CITA) systems. These third party applications provide the ability to generate trusted cyberspace digital identity tokens to be used for processing cyberspace transactions between two cyberspace parties.

Another objective of the invention is for said security module to support attestation capabilities, such that third party CITA applications can be guaranteed for authenticity. This objective ensures man-in-the-middle attacks against said security module are eliminated.

Another objective of the invention is for said security module to utilize PKI methodologies, digital signature, data hashing, and data encryption services to support the establishment of mutually authenticated and secured communication links between two cyberspace parties and the exchange of encrypted, and digitally signed cyberspace digital identity tokens. This objective ensures the privacy and integrity of cyberspace transactions.

Another objective of the invention is for said security module to be implemented via software, hardware, or in firmware, to support easy integration with commercial electronic devices. This objective supports the electronic device commercial market's ability to easily incorporate the security module into their existing products.

A final objective of the invention is to utilize a cyberspace user's electronic device, coupled with the security module, as the means for establishing trusted identities between two cyberspace parties, thus eliminating the need for cyberspace users to carry man-made tokens, i.e., ID cards, credit cards, etc. to gain access to services or make payments for services provided. This objective further reduces the cost burden to financial institutions and government agencies for producing and maintaining said man-made tokens, the cost savings of which can ultimately be passed on to the consumer.

### BRIEF SUMMARY OF THE INVENTION

The invention presented within satisfies the needs addressed above by providing a Security Module; the Cyberspace Trusted Identity (CTI) Module, which can be coupled with any commercial electronic device. An electronic device may include a desktop PC, laptop PC, tablet PC, smart phone, or other iterations of electronic devices supporting electronic computing and communication mechanisms. As well, electronic devices are not limited to personal computing devices as the security module can also be incorporated into enterprise devices such as servers and network appliances.

The CTI Module provides the mechanism to securely store personal identity attributes and cyberspace user digital identity tokens, and provides a security infrastructure for conducting safe and reliable cyberspace transactions. Personal identity attributes may include; name, address, date of birth, phone number, email addresses, financial account information, medical account information, club membership information, web portal accounts, or any other personal identity information a device owner may wish to securely maintain. Cyberspace digital identity tokens are exchanged between a cyberspace consumer and a cyberspace service provider as a means of automatically authenticating the identity of the cyberspace user in order for the consumer to gain access too, or make payment for services provided. These digital identity tokens are comprised of a cyberspace user's personal identity attributes, e.g., user name, password, financial account number, etc., and are encrypted and digitally signed by a trusted third party system; a Cyberspace Identification Trust Authority (CITA) system.

The CTI Module presented under this invention is a key component of an enterprise cyberspace trusted identity solution, as presented under Provisional Patent # 61/602,431. As evidenced under that patent, the overall solution is comprised of a Third Party System—the Cyberspace Identification Trust Authority (CITA) system, and a network of cyberspace users, which can be acting as consumers of cyberspace services, or service providers of cyberspace services. The cyberspace users use their electronic devices (connected to the internet or through an intranet) to interact with each other in conducting cyberspace transactions, and utilize the security infrastructure provided through their CTI Module on their electronic device to safeguard the integrity and privacy of the transaction undertaking, coupled with cyberspace digital identity tokens assigned through the CITA, to establish mutually authenticated and trusted identities between two cyberspace parties. As such, the CITA provides the mechanism for cyberspace consumers and service providers to interact effectively and efficiently under a trusted and secure cyberspace environment. Consumers utilize the services provided by service providers and rely upon the CITA to authenticate identity attributes to permit access to services desired, or make payment for services obtained. For example, a consumer may be a web surfer attempting to gain access to a service provider's web portal which requires a user id and password and relies upon the CITA assigned digital identity access token to provide these identity credentials in order to gain access. Once authenticated the consumer may further rely upon the CITA to process a payment for purchases made through the on-line web portal using a digital identity payment token. Service Providers on the other hand provide services to consumers and rely upon the CITA to authenticate the identity of the consumers they service through CITA assigned digital identity tokens, and/or confirm that payments have been made for services provided through CITA assigned digital identity payment tokens. For example, a service provider may be a retail establishment like a movie theatre or nightclub that requires proof of age before entering and relies upon the CITA to authenticate the consumer meets the access restrictions to grant access, thus the service provider does not require the consumer to provide a man-made token, e.g., driver license, passport, etc. to authenticate their age. Once the service provider provides access to the service they may further rely upon the CITA to confirm that payments have been made for the services provided to the consumer.

CITA digital identity tokens are encrypted and digitally signed by the CITA and are based upon adaptations of industry standard data tokens, e.g., JSON Web tokens, X.509 digital certificates, etc. and are dynamically created by the CITA to contain only the minimal identity attributes required to successfully conduct a cyberspace transaction, as well as the unique CTI Module Device ID(s) registered under the device owner's CITA account, thereby eliminating the need for cyberspace users to openly divulge personal information not directly related to the cyberspace transaction. Encrypting the unique CTI Module Device ID within the CITA token enables the CITA token to be authenticated as originated from the registered device. Thus, when used in conjunction with an electronic device and a third party CITA application, the secure storage capabilities provided under the CTI Module eliminates the need for cyberspace users to hold in their procession man-made identity tokens, or openly divulge and/or exchange personal identity information when conducting a cyberspace transaction. In addition, once a CITA digital identity token is established for a cyberspace user, and securely maintained on their electronic device's CTI module, the device owner can re-access the CTI module through biometric authentication and retrieve their digital identity token for a subsequent cyberspace transaction without the need to interact with the CITA. Thus, established CITA digital identity tokens stored on the security module can be re-used through a secure mechanism, thereby eliminating the need to subsequently establish a trusted identity through the CITA, and eliminating the need for a cyberspace party to remember or maintain multiple identity attributes for accessing cyberspace services.

As well, the security module presented under this invention incorporates all of the standard features and functionalities present in a Trusted Platform Module (TPM) security infrastructure, to include; PKI methodologies, digital signature, data hashing, data encryption, key generation, and protected storage capabilities. In addition to the CITA specific digital identity token processing capabilities available within the CTI module under this new invention, what makes this invention unique to the standard TPM offering is the expanded storage capacity to support secure, on-board storage of personal identifier attributes and CITA digital identity tokens (typically stored outside a TPM in an encrypted file system) and the use of on-board multi-modal biometric identification capabilities to authenticate proper access to the CTI module (typically performed through password or pass phrase authentication on a TPM). This new and innovative approach not only safeguards and protects the privacy and integrity of personal identifier attributes and cyberspace digital identity tokens by providing storage within the CTI module, it also employs multi-modal biometric identification technology (within the module) to overcome the present day TPM limitations that are vulnerable to dictionary attacks to circumvent password/passphrase protection mechanisms. As such, this new and innovative approach provides an advanced security infrastructure to protect personal identity attribute information and cyberspace digital identity tokens used for conducting safe and reliable cyberspace transactions, as well as standard security mechanisms to protect the privacy and integrity of information exchanged between two cyberspace parties.

As the CTI Module is intended to provide safe and reliable storage for personal identity attributes and cyberspace digital identity tokens, and the secure management of keys used for mutual authentication, data encryption, and digital signature operations, the module must include security mechanisms to safeguard these attributes to ensure that only the rightful owner has access to the information. To support this capability the CTI Module employs multi-modal biometric identification technology, which provides the ability to “lock” the CTI module to a specific owner. Once an electronic device owner registers their biometric samples to the CTI module the module automatically transitions from an “open” state to a “locked” state, and subsequent access to the module (or the information stored within the module) is only permitted after successfully submitting live biometric samples to the module, and the module successfully biometrically matching these live samples to the registered biometric samples. Note: The biometric matching operation is performed within the CTI module to provide the highest levels of security. If the offered biometric samples are authenticated by the CTI module then access to the secure storage area of the module and the security features inherent to the module is granted. If the offered biometric samples are not authenticated then access to the security module is denied.

### BRIEF DESCRIPTION OF THE SEVERAL VIEWS OF THE DRAWING

FIG. 1—Presents a schematic diagram of the preferred embodiment of a Cyberspace Trusted Identity (CTI) Module incorporated with an Electronic Device.

FIG. 2—Presents a representative schematic diagram of the preferred embodiment of a third party computer application program hosted on an electronic device and interfacing with the Cyberspace Trusted Identity (CTI) Module.

FIG. 3—Presents a representation of the CTI Module I/O command structure, defining the preferred Input and Output command format and describing the contents of the data elements within a CTI Module command.

FIG. 4—Presents a listing of example CTI Module commands, defining the use of the command and the intended inputs and outputs of the command.

FIG. 5—Presents a diagram depicting the representative CTI Module Interface Gateway Component processing workflow.

FIG. 6—Presents a diagram depicting the representative CTI Module Biometric Matcher Component processing workflow.

FIG. 7—Presents a listing of example CITA tokens envisioned to be used by the invention to support CITA system transactions and defines the contents and use of each token and how they are exchanged between a Consumer, Service Provider, and the CITA system.

FIG. 8—Presents a diagram depicting the representative CTI Module Token Manager Component processing workflow—Part 1. For simplicity and clarity the representative CTI Token Manger Component processing workflow is presented across 3 separate figures.

FIG. 9—Presents a diagram depicting the representative CTI Module Token Manager Component processing workflow—Part 2.

FIG. 10—Presents a diagram depicting the representative CTI Module Token Manager Component processing workflow—Part 3.

FIG. 11—Presents a diagram depicting the representative CTI Module Storage Manager Component processing workflow.

FIG. 12—Presents a diagram depicting the representative CTI Module Cryptography Services Component processing workflows.

### DETAILED DESCRIPTION OF THE INVENTION

The components shown in the figures presented within this invention, their connectivity to other components, their functions, and their relationships with other components depicted within are intended to be representative only, and are not intended to limit the implementations of the invention and/or the claims specified under this invention. The order in which components, functions, or processes is presented is representative only, and various implementations approaches may be taken without contradicting and/or violating the spirit and scope of this invention.

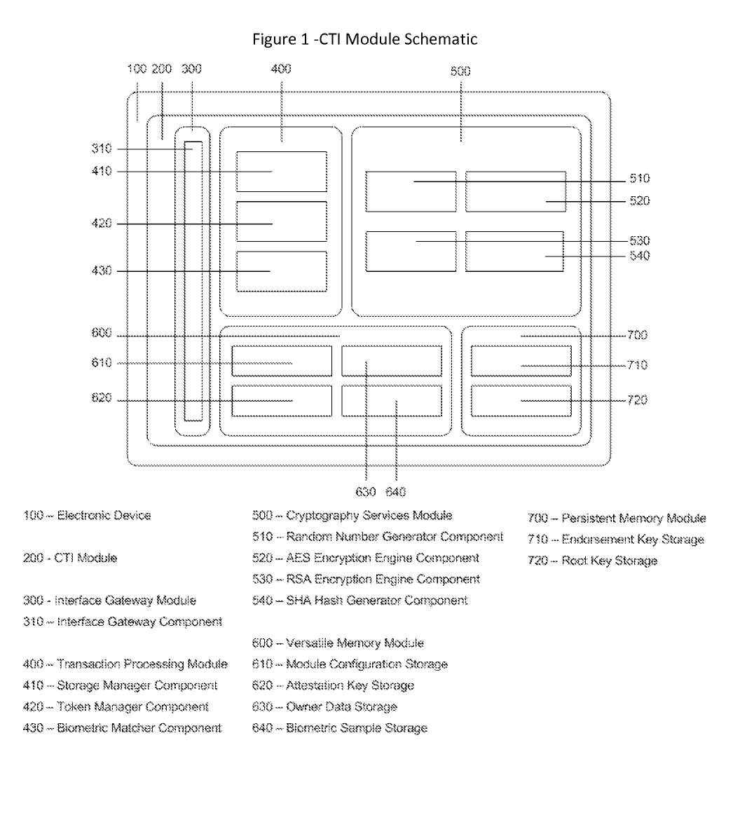

In FIG. 1 a Security Module (200); the Cyberspace Trusted Identity (CTI) Module, is a security component that can be coupled with an electronic device (100). The electronic device shown in this drawing is intended to represent any form of an electronic device supporting electronic computing and communication mechanisms.

In various implementations the Security Module may be implemented in hardware, software, or firmware on an Application Specific Integrated Circuit (ASIC) chip featuring System-on-Chip (SOC) technology. As well, in various iterations the Security Module may combine multi-modal biometric identification technology, data encryption technology, hashing functions, and digital signature operations through a PKI security infrastructure.

The Security Module incorporates an Interface Gateway Module (300) for controlling secure access to the module; a Transaction Processing Module (400), for processing commands performed against the module; a Cryptography Services Module (500), providing data encryption, digital signature, data hashing, and random number generation services; a Versatile Memory Module (600), providing secure storage for PKI keys, attestation keys, owner identity attributes and personal information, owner cyberspace digital identity tokens, and owner biometric samples; and a Persistent Memory Module (700), providing secure storage for the CTI Module private keys used for data encryption and digital signature operations, as well as the security module's unique Device ID.

The Interface Gateway Module (300) is further comprised of an Interface Gateway Component (310).

The Transaction Processing Module (400) is further comprised of; a Storage Manager Component (410); a Token Manager Component (420); and a Biometric Matcher Component (430).

The Cryptography Services Module (500) is further comprised of; a Random Number Generator Component (510); an AES Encryption Engine Component (520); a RSA Encryption Engine Component (530); and a SHA Hash Generator Component (540).

The Versatile Memory Module (600) is further comprised of; Module Configuration Storage (610); Attestation Key Storage (620); Owner Data Storage (630); and Biometric Sample Storage (640).

The Persistent Memory Module is further comprised of Endorsement Key Storage (710) and Root Key Storage (720).

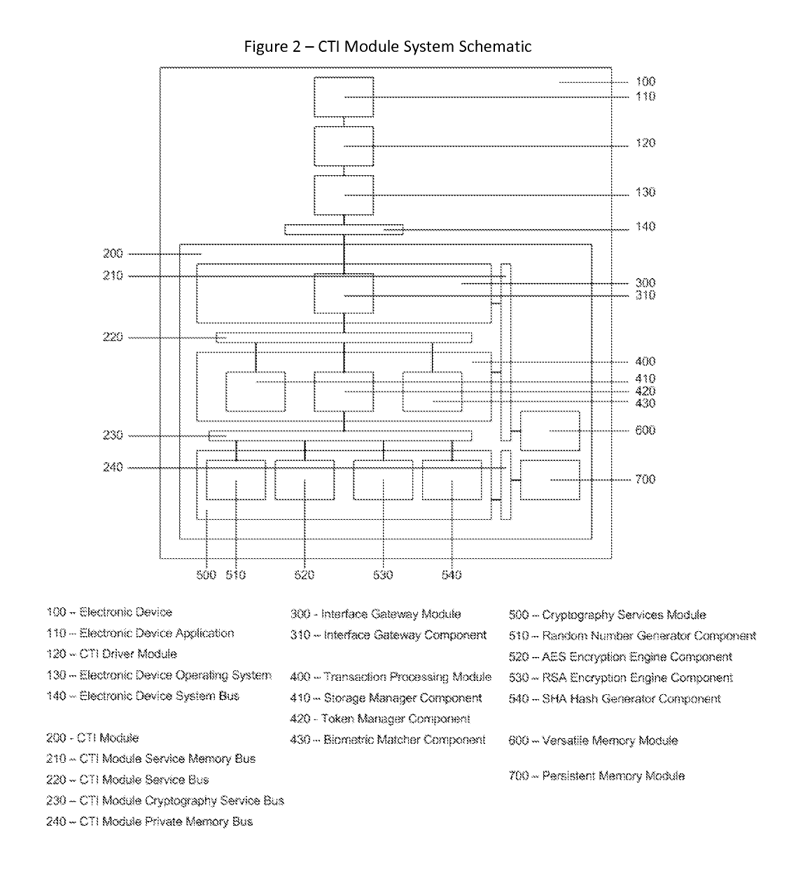

The preferred architecture for CTI Module integrated with an electronic device is comprised of multiple layers, as presented under FIG. 2. An Electronic Device Application (110) hosted on the Electronic Device (100) interfaces with the CTI Driver Module (120), which in turn interfaces with the Electronic Device Operating System (130) to gain access to the Electronic Device System Bus (140), which provides connectivity to the CTI Module (200).

Under this invention the Electronic Device System Bus (140) can be the electronic device's internal CPU or Memory bus, a Universal System Bus (USB), an expansion port bus, or any electronic system bus supporting the ability to communicate electronically with the CTI Module. In various implementations the CTI Module can be implemented as an internal component integrated with the electronic device mother board, or as an external peripheral to the electronic device.

The CTI Module (200) is further comprised of an Interface Gateway Module (300); a Transaction Processing Module (400); a Cryptography Services Module (500); a Versatile Memory Module (600); and a Persistent Memory Module (700).

The Interface Gateway Module (300) is the only interface point to the CTI Module and connects to the CTI Driver Module (120) via the Electronic Device Operating System (130) and Electronic Device System Bus (140). The Interface Gateway Module (300) is further comprised of one component; the Interface Gateway Component (310), which controls all input/output command processing capabilities on the module. The Interface Gateway Component (310) also has access to the module's Versatile Memory Module (600) via the CTI Module Service Memory Bus (210).

The Transaction Processing Module (400) provides all CTI Module command processing capabilities to include; biometric registration and authentication commands; CITA token processing commands; and module storage commands, and is further comprised of; a Storage Manager Component (410); a Token Manger Component (420); and a Biometric Matcher Component (430). These modules connect to the Interface Gateway Component (310) via the CTI Module Service Bus (220). These modules also have access to the module's Versatile Memory Module (600) via the CTI Module Service Memory Bus (210).

The Cryptography Services Module (500) provides all data encryption and digital signature operations on the module and is further comprised of; a Random Number Generator Component (510); an AES Encryption Engine Component (520); a RSA Encryption Engine Component (530); and a SHA Hash Generator Component (540). These components connect to the Token Manager Component (420) via the CTI Module Cryptography Service Bus (230). These components are the only CTI Module components with access to the Persistent Memory Module (700), via the CTI Module Private Memory Bus (240) for accessing the endorsement key and root key for digital signature and data encryption operations.

The CTI Module is a command driven device that can operate under various modes of operations. For example, in one implementation mode under this invention the CTI Module can operate in a synchronous mode of operations, where one command is presented to the module at a time and the module provides a response to the command before processing another command. In another instance of the invention the module can operate in an asynchronous mode of operations and can process multiple commands in parallel.

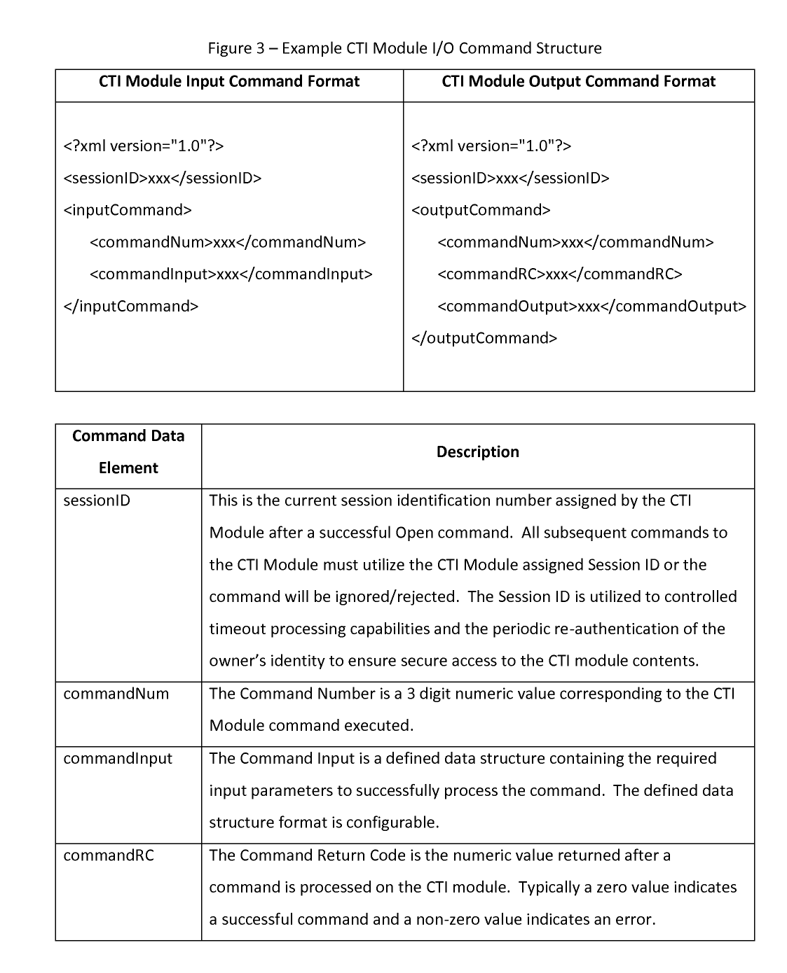

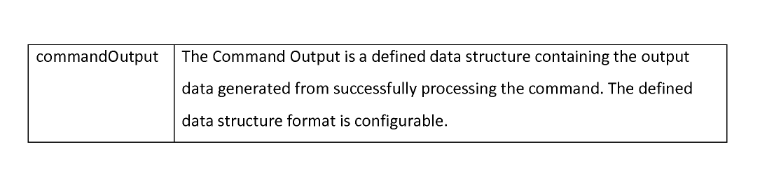

The Inputs/Outputs to the CTI module are based upon command data objects, passed in memory between the CTI Module Interface Gateway Component (310), via the CTI Driver Module (120), and an Electronic Device Application (110) hosted on the Electronic Device (100). As presented under FIG. 3, the command data objects are presented to the CTI Module in an XML schema definition (XSD) format. Alternate implementations of the invention can support any other commonly accepted data formatting standards available within the computer programming industry. There is a defined data format, i.e., XLM Schema Definition, for each input command and one for each output command response and third party computer program application developers can custom configure the default data format definitions to expand upon the data elements to be stored and maintained on the CTI module. Thus, a third party computer program application developer can utilize the CTI Module to support a simple electronic vault to store personal information pertaining to the device owner, provide expanded definitions of specific financial accounts or club memberships pertaining to the owner, or can provide increased functionality to support CITA type access requests or payment requests service processing capabilities using the CTI Module security features.

The CTI Module operates under the concept of a session, which is controlled through an internal and private configuration registry that is dynamically maintained by the CTI Module components. The internal configuration settings are private to the module and cannot be updated by a third party computer program application as they control the processing state of the CTI Module. A key parameter included under the private configuration settings is the Session ID, which is established through an Open Command and cleared with a Close Command. Every time a new session is initiated with the CTI Module the Interface Gateway Component creates a random Session ID, which must be included with all subsequent commands presented to the module during the given session. When a session is closed the Session ID in the private configuration settings is cleared, signifying the module is effectively in a “closed” or “locked” state, thus the Interface Gateway Component will not process any other commands received until a successful Open command is processed and a new Session ID is re-established.

Additional control parameters included under the private configuration settings include, but are not limited to tracking; if the module has been registered under a CITA by the electronic device owner, if the owner has been authenticated during a given session, if the owner has defined a profile on the module, the number of failed authentication checks before automatically closing a session, and the timeout value associated with an active session. The Session Timeout value controls the ability to periodically require the owner to re-authenticate their identity to the module. This security feature ensures the electronic device cannot be left un-attended for a period of time where a third party application could be operating on the device and leave the CTI Module in an “open” state. In such an instance (assuming the session ID was fraudulently made available to an un-trusted application) access to the data stored on the module could be obtained for fraudulent purposes without this timeout feature in place. When the Session Timeout value is exceeded the IGC automatically returns a session timeout error for all subsequent commands received, which requires the owner to biometrically re-authenticate their identity to the module to continue processing a session.

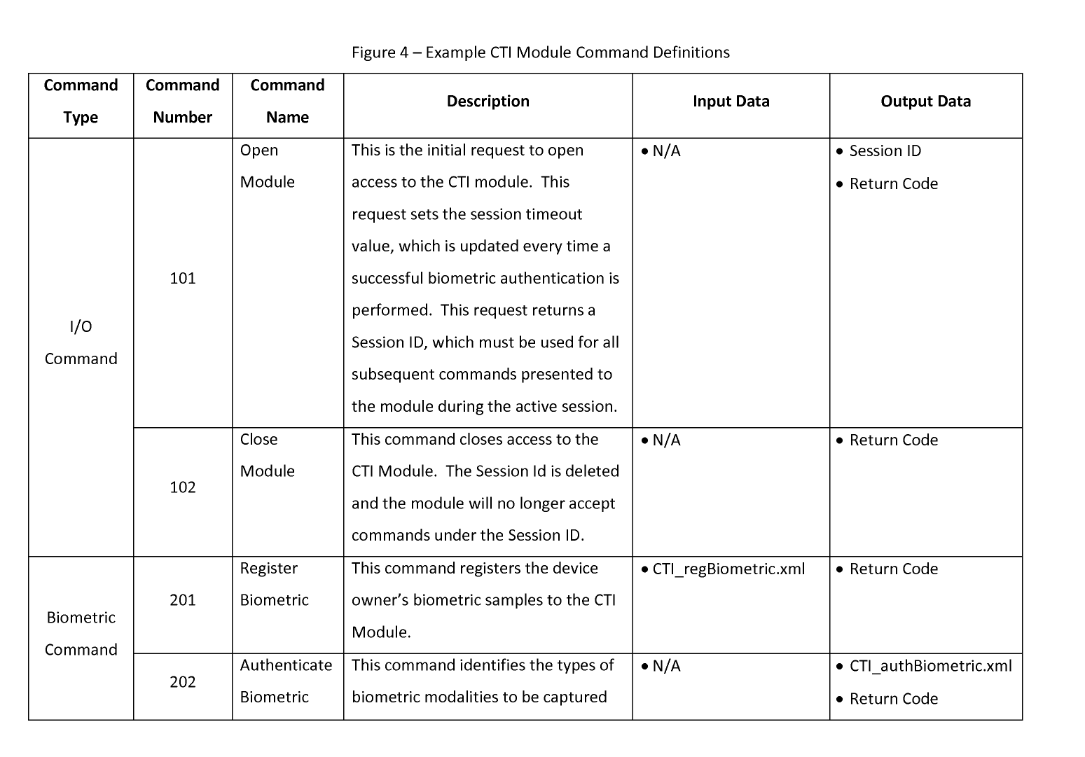

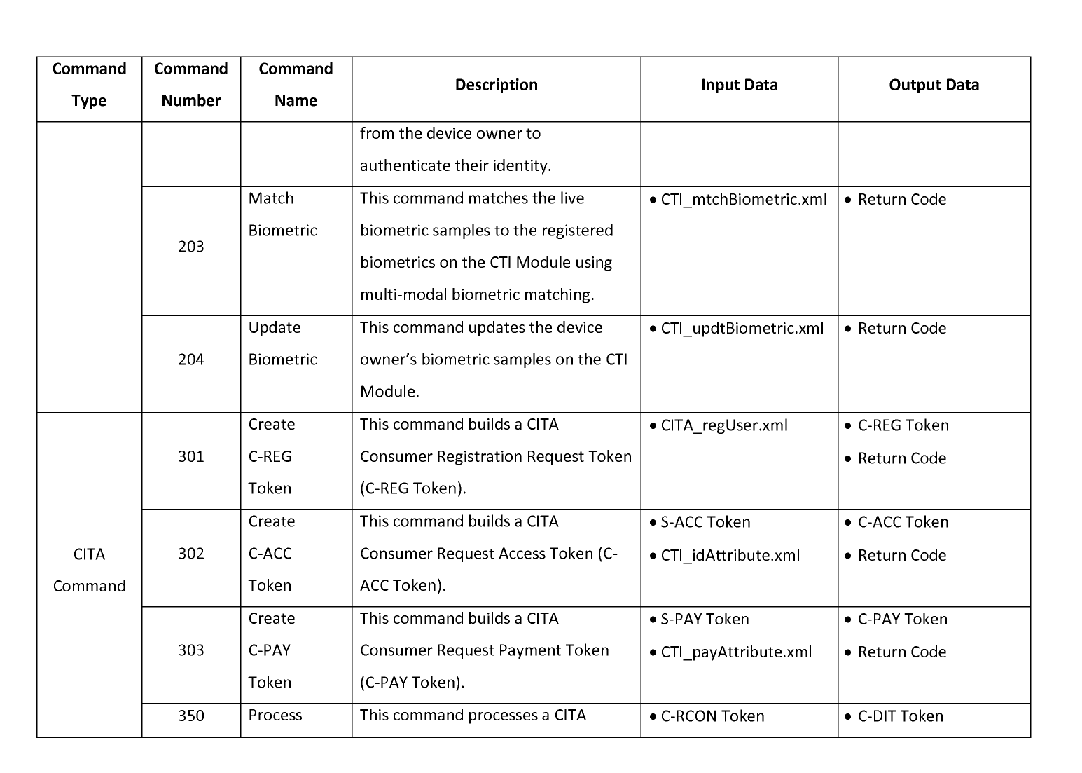

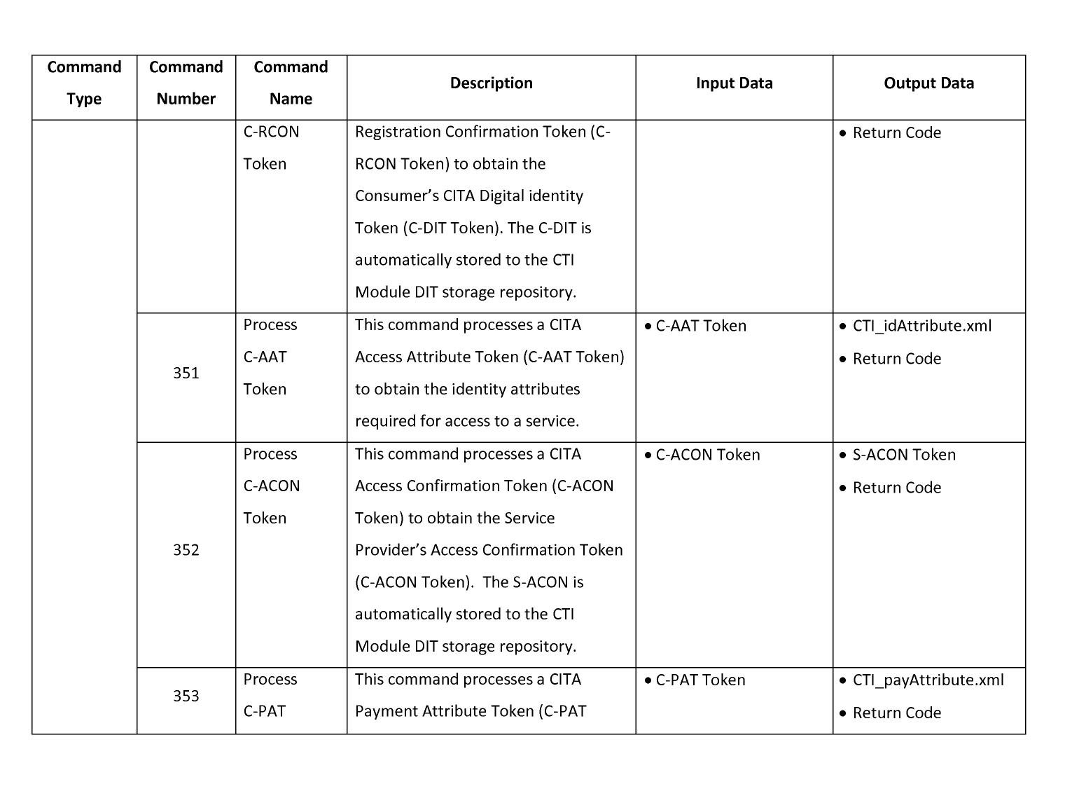

As presented under FIG. 4, which defines example commands supported by the CTI Module, there are four levels of CTI Module commands; I/O Commands, Biometric Commands, CITA Token Commands, and Storage Commands. Under one implementation of the invention each command may be associated with a specific command number or command name, where the command numbering scheme and/or naming convention is customizable and controlled through a public configuration registry. The number of commands supported by any given implementation of the CTI Module may vary between Third Party application developers, where certain commands may be utilized under one implementation approach and other commands, or additional commands, are utilized under an alternative implementation approach. The command number schemes, naming conventions, and associated processing functionality presented within this invention are representative only, and are not intended to limit the implementations of the invention and/or the claims specified under this invention. As such, various implementations approaches may be taken by Third Party application developers without contradicting and/or violating the spirit and scope of this invention.

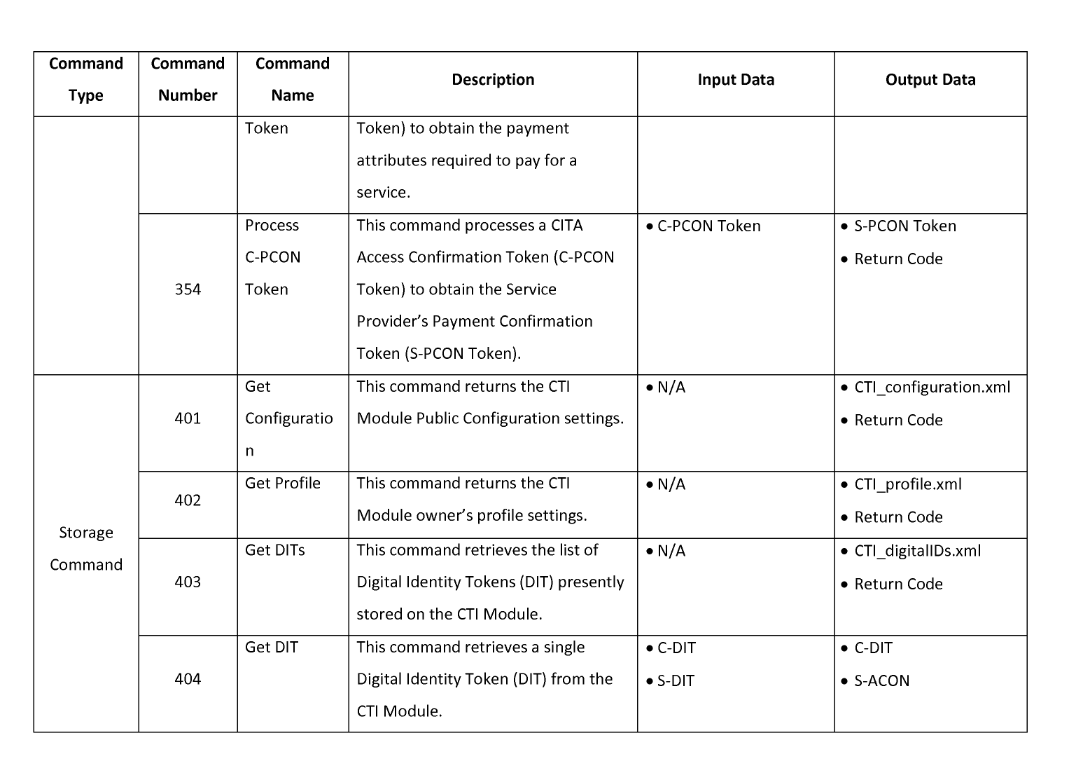

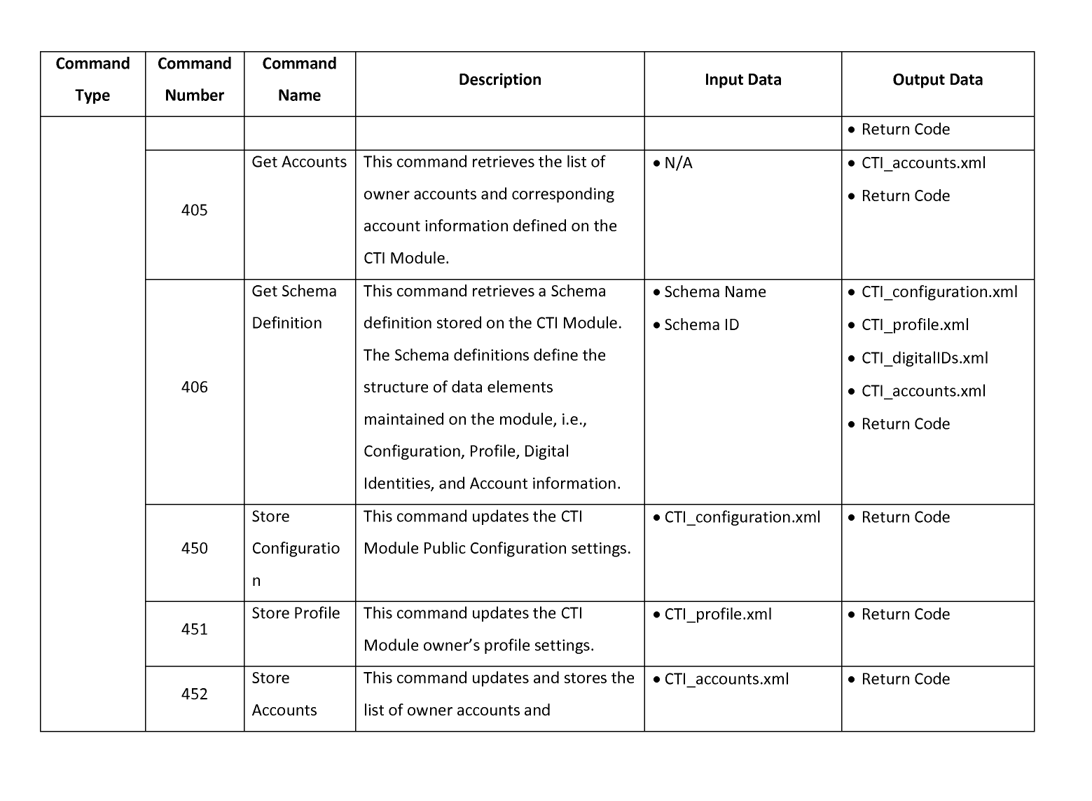

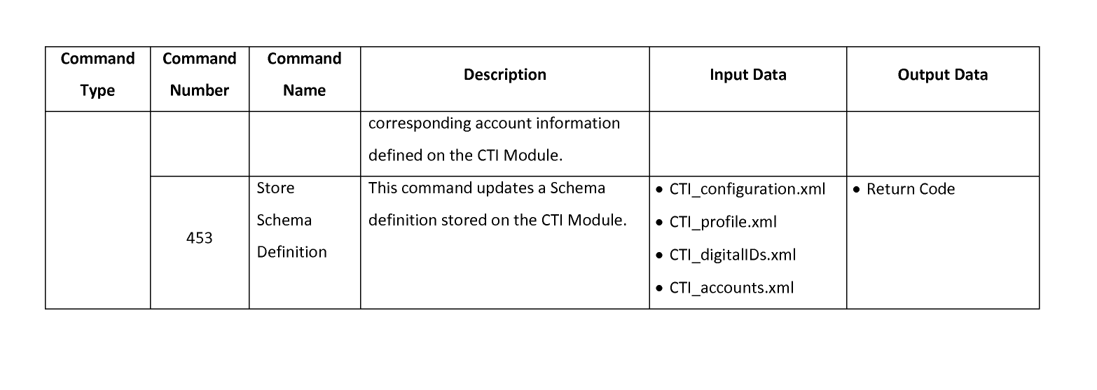

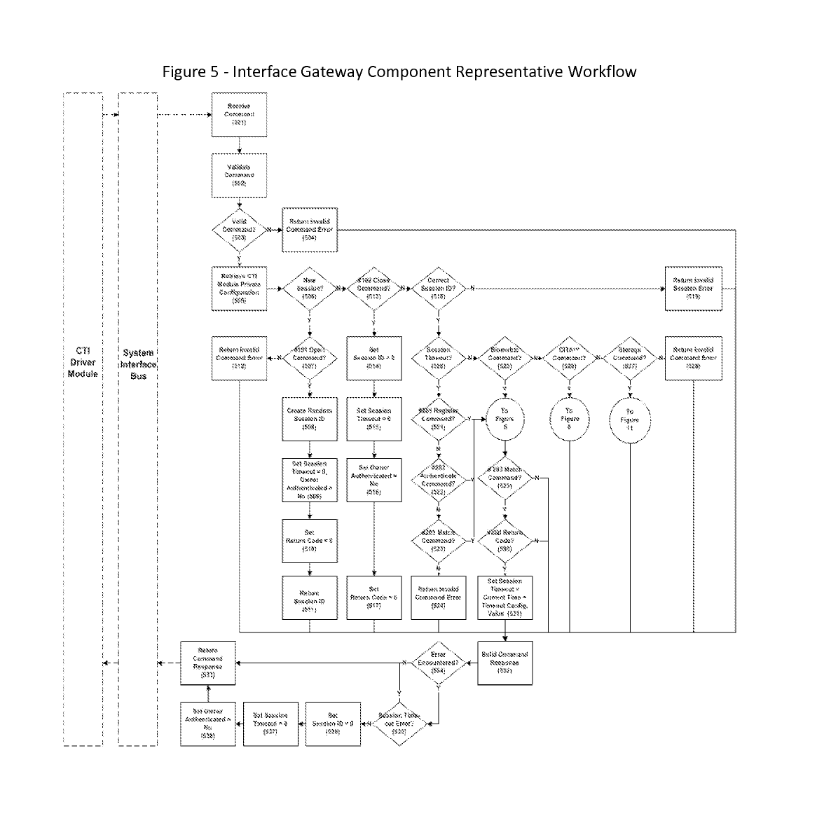

An example of a representative workflow processing logic for the Interface Gateway Component (IGC) is presented under FIG. 5. The IGC is the only point of entry to the CTI Module and processes all transactions received by the CTI Module. Under the implementation example presented within the IGC processes an Open Command (Command # 101 under FIG. 4) and a Close Command (Command # 102 under FIG. 4). Additional commands may be supported under alternative implementations of the invention, which may include support for asynchronous processing, support for multiple owner profiles, support for establishing mutually authenticated links, and support for concurrent sessions with multiple third party computer program application interfaces.

As depicted under FIG. 5, the IGC receives a command (Step 501) via the CTI Driver Module across the electronic device system bus and first validates the command (Step 502) for proper syntax against the registered command control format definition. This validation check also includes a security authentication of the submitting application, which performs an Attestation key verification to authenticate the submitting application and protect against man-in-the-middle attacks by rouge software applications. If an error is encountered, (Step 503) the IGC returns an error response (Step 504). If the command is validated, the IGC continues processing the command and retrieves the CTI Module private configuration settings (Step 505).

The next check the IGC performs is to see if a new session is being established (Step 506), which is controlled through the Session ID. If this is a new session the only valid command the IGC will process is an Open command (Step 507), which will generate a new random Session ID (Step 508), set the Session Timeout value and Owner Authenticated value (Step 509), set the return code as valid (Step 510) and return the Session ID in the command response (Step 511). This approach thus enforces the policy that a Register Biometric, Authenticate Biometric, or Match Biometric Command is the only possible valid commands to be subsequently accepted by the module after a successful Open command, which ensures the owner's identity is biometrically authenticated before any subsequent processing on the module will be performed. If an Open command is not presented to the module as expected, an error condition is returned (Step 512).

If a command is presented under an active Session ID a check is performed to see if a Close Command (Step 513) has been presented to the module. The Close Command resets the Session ID (Step 514) and Session Timeout value (Step 515), and resets the Owner Authenticated flag (Step 516), and returns a successful return code (Step 517). Thus, no additional command processing will be supported by the module until a successful Open Command is processed.

If the presented command is not a Close Command the IGC validates the command is consistent with the current session by checking the Session ID included with the command (Step 518). If the offered Session ID does not match the active Session ID in the private configuration settings an error is returned (Step 519) and the command is ignored. If the Session ID is valid, the IGC then checks for a timeout condition (Step 520), where the current system time exceeds the private Session Timeout setting. If this is true the only command the IGC will accept is a Register Biometric, Authenticate Biometric, or Match Biometric Command (Steps 521-523). All other commands received will respond with an error (Step 524) and the command will be ignored.

If a session timeout event does not exist the command is passed to the subsequent components under the Transaction Processing Module based upon the command referencing methodology established under the implementation approach. For example; commands in the #200 range are passed to the Biometric Manager Component (Step 525); commands in the #300 range are passed to the Token Manager Component (Step 526); and commands in the #400 range are passed to the Storage Manager Component (Step 527). If a command is presented that is not available within the implementation configuration an error response is returned (Step 528). It is noted that if the command was a Match Command (Step 529) and the response is valid (Step 530), (i.e., the owner's identity was authenticated through biometric matching) the IGC updates the private configuration Session Timeout value (Step 531). This ensures that commands will continue to be subsequently processed for the active session. Once the command response is received from the underlying modules the IGC formats the appropriate command response message (Step 532) and passes it back to the CTI Driver Module (Step 533). It is noted that if an error was encountered (Step 534) in processing the command and the error was a time-out error (Step 535) the IGC automatically closes the module by re-setting the module Session ID (Step 536), Session Timeout value (Step 537), and Owner Authenticated value (Step 538).

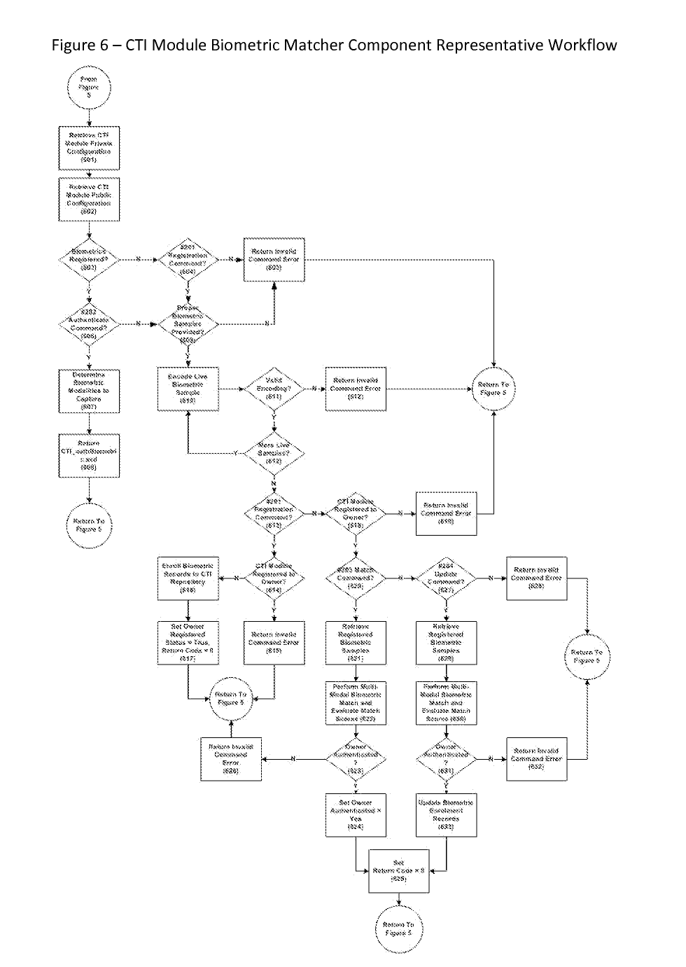

An example of a representative workflow processing logic for the Biometric Matcher Component (BMC) is presented under FIG. 6. The BMC is responsible for processing biometric commands using multi-modal biometric identification technology, which includes support for fingerprint, face, and voice biometrics under one instance of the invention. Alternative instances of the invention include support for additional biometric modalities, which includes but is not limited to both physical and behavioral biometric modalities, e.g., DNA, iris, gate, keystroke, etc. The BMC accepts biometric samples based upon industry standard data formats, which may include; CBEFF, ANSI/NIST-ITL, and other data record formats commonly accepted within the biometrics industry.

Under the representative example workflow logic presented within this invention the BMC accepts a Register Biometric Command (Command # 201 under FIG. 4), Authenticate Biometric Command (Command # 202 under FIG. 4), Match Biometric Command (Command # 203 under FIG. 4), and an Update Biometric Command (Command # 204 under FIG. 4). Additional command levels supported under alternative implementations of the invention include but are not limited to; support for biometric authentication against multiple owner profiles, and support for additional biometric modalities, as described above.

As depicted under FIG. 6, the BMC first retrieves the private configuration settings (Step 601) and then the public configuration settings (Step 602). The CTI Module provides support for public configuration settings, which can be altered by the device owner to control amongst other things the processing logic on the module. One such example is the authentication mode configuration settings, which enables an owner to define; the types of biometric samples required for authenticating ownership, the number of samples required, i.e., 2 fingers, 1 face, 1 voice, etc.; and the match probability rate for validating authentication, i.e. the biometric matching score threshold. This feature of the invention improves the usability of the CTI Module and enables the owner to establish preferred security policies for accessing CTI Module data elements. For example, providing access to review the owner profile settings may require only one biometric sample to be presented, whereas accessing financial account information may require more stringent controls and require additional biometric samples to be presented and authenticated.

The first check performed by the BMC is to check if biometric samples have already been registered to the CTI Module (Step 603). If biometric samples have not been registered the only valid command accepted by the BMC is a Registration Command (Step 604). If a Registration Command was not submitted an error condition is returned (Step 605) to the IGC. If biometric samples have been registered to the module the next check the BMC performs is to see if an Authenticate Biometric Command was submitted (Step 606). The Authenticate Biometric command is used to determine the type of biometric samples that must be provided in order to gain access to the module. If an Authenticate Command was submitted the BMC uses the public configuration settings to determine the type of biometric modalities that are required to be captured from the owner (Step 607) and returns the results in the CTI_authBiometric.xml response (Step 608) to the IGC.

It is noted that this determination also includes a dynamic modality assessment security feature under the present invention to enhance the security of the CTI Module. This enhanced security feature can be activated based upon the device owner's specified security settings in the public configuration registry. The dynamic biometric modality assessment feature provides for a random determination of a biometric modality to be authenticated utilizing a “Completely Automated Public Turing test to tell Computers and Humans Apart”, i.e., CAPTCHA methodology. For example, when a voice print biometric sample is to be provided, and the enhanced security feature is enabled, a dynamically defined phrase containing letters, numbers, and key words, e.g., “A 7 9 X I Bus Stop” is generated and returned in response to the Authentication request. The Owner must repeat this phrase in the offered live biometric sample in order to be authenticated to the CTI Module. For fingerprint biometrics it would include a random order and number of fingerprint impressions to be provided and for facial biometrics it would include random 3 dimensional poses to be provided. This enhanced security feature ensures the CTI Module cannot be compromised by fraudulent biometric samples or automated samples as generated from a computer application due to the random nature of the CAPTCHA approach.

It the submitted command was not an Authenticate Biometric command, or a register Biometrics command was submitted, the BMC will next validate that the offered live biometric samples correspond with the public configuration settings for registering or authenticating identity ownership to the module (Step 609). The BMC uses these settings to verify the offered biometric samples correspond to what is required (as defined under the public configuration settings defined by the device owner) to successfully conduct a registration, match or update operation. If the required biometric samples are not provided an error condition is returned (Step 605) to the IGC.

If the command contents are valid the BMC next encodes (Step 610) the live biometric samples provided in the command to extract the feature data elements required to perform a multi-modal biometric match operation. Again, if an error is encountered (Step 611) in encoding the live biometric samples, i.e., image formatting error, poor quality error, etc., an error condition is returned (Step 612) to the IGC. Once the live biometric samples are encoded (Step 612), the BMC next checks to see if a Register Biometric Command (Step 613) was submitted to the module. If a Register Biometric Command was submitted the BMC next checks to see if the module has already been registered by an Owner (Step 614). If biometric samples have already been enrolled under an owner profile an error condition is returned (Step 615) to the IGC. Note: This implementation approach assumes the module is configured to support only a single user profile, whereas alternative implementation approaches may provide support for multiple user profiles. If biometric samples have not been registered under the owner profile the biometric samples are saved to the CTI Module biometric storage repository (Step 616) and the final step for processing the Register Biometric Command would include setting the private configuration setting for the Owner Registered value and returning a successful return code (Step 617) to the IGC.

If the submitted command was not a Register Biometric Command the BMC next validates the CTI Module has already been registered to an owner (Step 618). If the module has not been registered to an owner then by definition no biometric records have been enrolled to the module so subsequent biometric commands, i.e., Match or Update, are not available, thus an error condition is returned (Step 619). If the module has been registered to an owner the next check is to see if the submitted command is a Match Biometric Command (Step 620). If a Match Biometric Command is presented the enrolled biometric samples are retrieved from the CTI Module biometric storage repository (Step 621) and matched against the offered live samples (Step 622), using multi-modal biometric matching methodologies. The BMC uses the public configuration settings specified by the device owner to determine match likelihood, and either approve or deny the identity of the owner. If the live biometric samples match the enrolled biometric samples (Step 623) the Owner Authenticated parameter in the private configuration setting is set to true (Step 624) and a successful command response is returned (Step 625) to the IGC. If the live samples do not match the enrolled samples an error condition is returned (Step 626) to the IGC. As discussed above, upon returning to the IGC a successful match return code automatically resets the Session Timeout parameter to the next timeout duration. As well, if an error condition is returned the CTI Module will automatically transition to a “closed” state and clear the Session ID.

If the submitted command was not a Match Biometric Command the BMC next checks to see if the command submitted was an Update Biometric Command (Step 627). The Update Biometric Command is intended to provide the ability to re-register higher quality biometric samples, thus avoiding the possibility of receiving false rejection responses during a Match Biometric Command. If the submitted command is not an Update Biometric Command, and all the available command options have been exhausted, an error condition is returned (Step 628). If an Update Biometric Command was submitted the BMC next repeats the same steps presented above to authenticate the offered live biometric samples match the registered biometric samples (Steps 629 through 631). This validation check ensures the owner's identity is verified at all times and that only the true owner of the registered biometric samples can update their registered samples with higher quality samples. If the offered biometric samples provided within the Update Biometric Command do not match the registered biometric samples an error response is returned (Step 632). If the match is successful the updated biometric samples are recorded to the CTI Module Biometric storage repository (Step 633) and a successful return code is returned (Step 625) to the IGC.

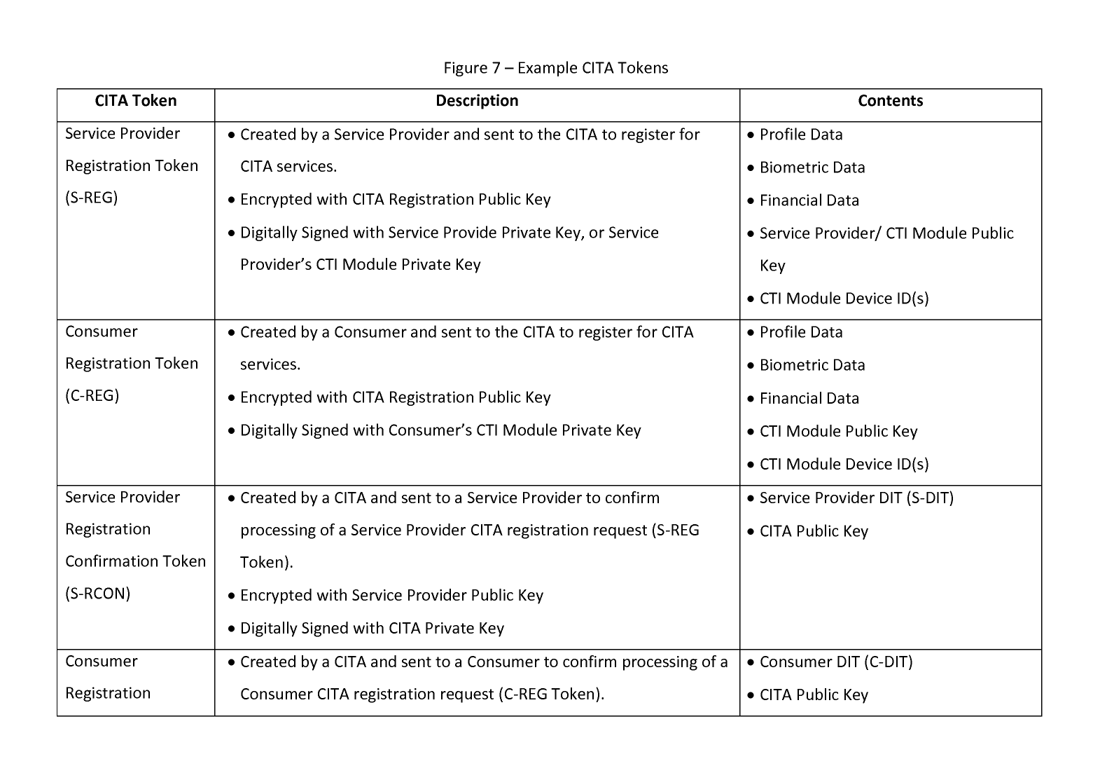

The Token Manager Component (TMC) is responsible for processing commands associated with CITA based transactions. CITA transactions performed by a Consumer using a CTI Module enabled electronic device include; Creating a CITA Registration Token (Command # 301 under FIG. 4); Creating a CITA Request Access Token (Command # 302 under FIG. 4); Creating a CITA Request Payment Token (Command # 303 under FIG. 4); Processing a CITA Registration Confirmation Token (Command # 350 under FIG. 4); Processing a CITA Access Attribute Token (Command # 351 under FIG. 4); Processing a CITA Access Confirmation Token (Command # 352 under FIG. 4); Processing a CITA Payment Attribute Token (Command # 353 under FIG. 4); and Processing a CITA Payment Confirmation Token (Command # 354 under FIG. 4). The Third Party CITA application operating on the Consumer's electronic device controls the communications with the CITA system, and utilizes the data cryptography services, secure storage mechanisms, and CITA token processing services provided by the CTI Module to manage the secure message processing capabilities required to conduct CITA based transactions. To protect the integrity and privacy of a CITA transaction the CITA messages are always encrypted and digitally signed, thus the TMC provides the ability to decode a CITA message provided by the CITA to extract the transaction data, or encrypt and digitally sign a CITA token to be presented to the CITA system. FIG. 7 defines examples of the types of CITA tokens envisioned to be supported under the present invention and provides a description of their use, content, and how they are passed between a Consumer, Service Provider, and/or the CITA system. Note: The CITA Token definitions of use, content, and exchange methodologies presented within this invention are representative only, and are not intended to limit the implementations of the invention and/or the claims specified under this invention. As such, various implementations approaches may be taken, to include defining additional token types, without contradicting and/or violating the spirit and scope of this invention.

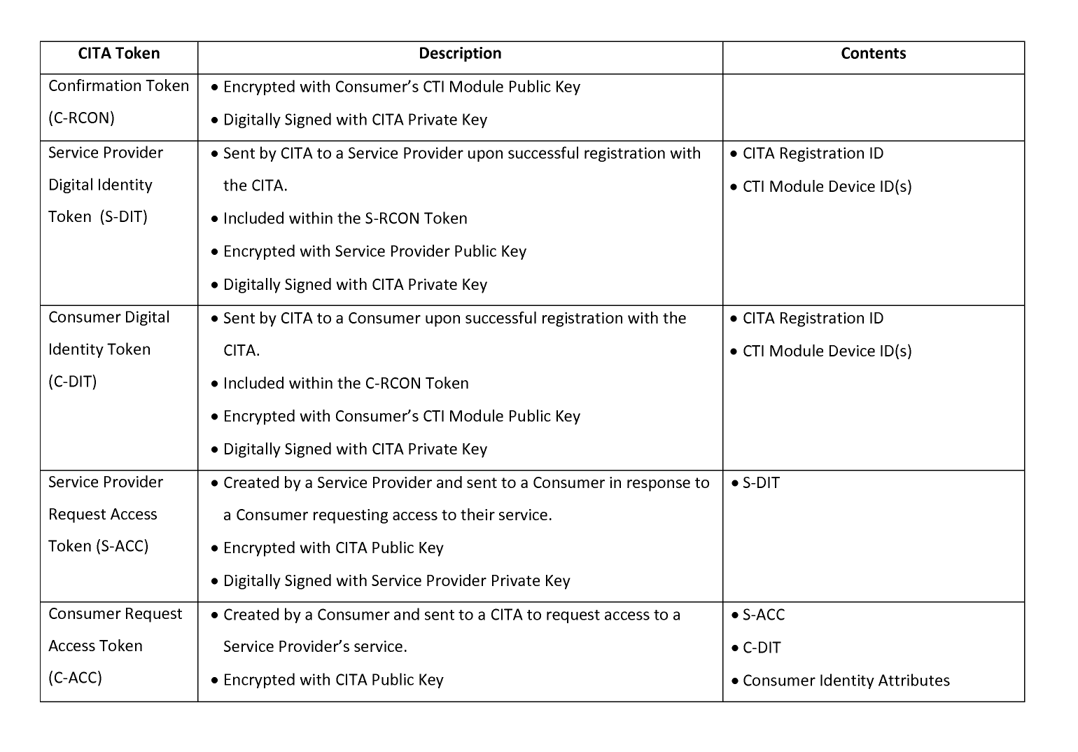

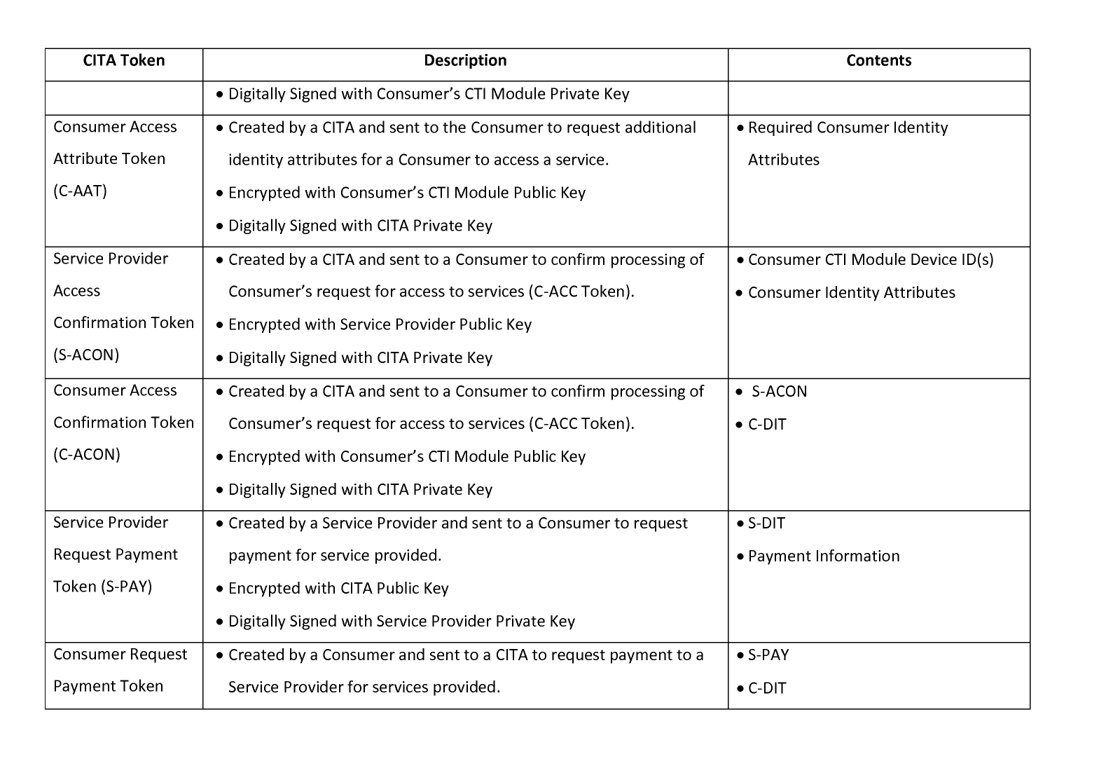

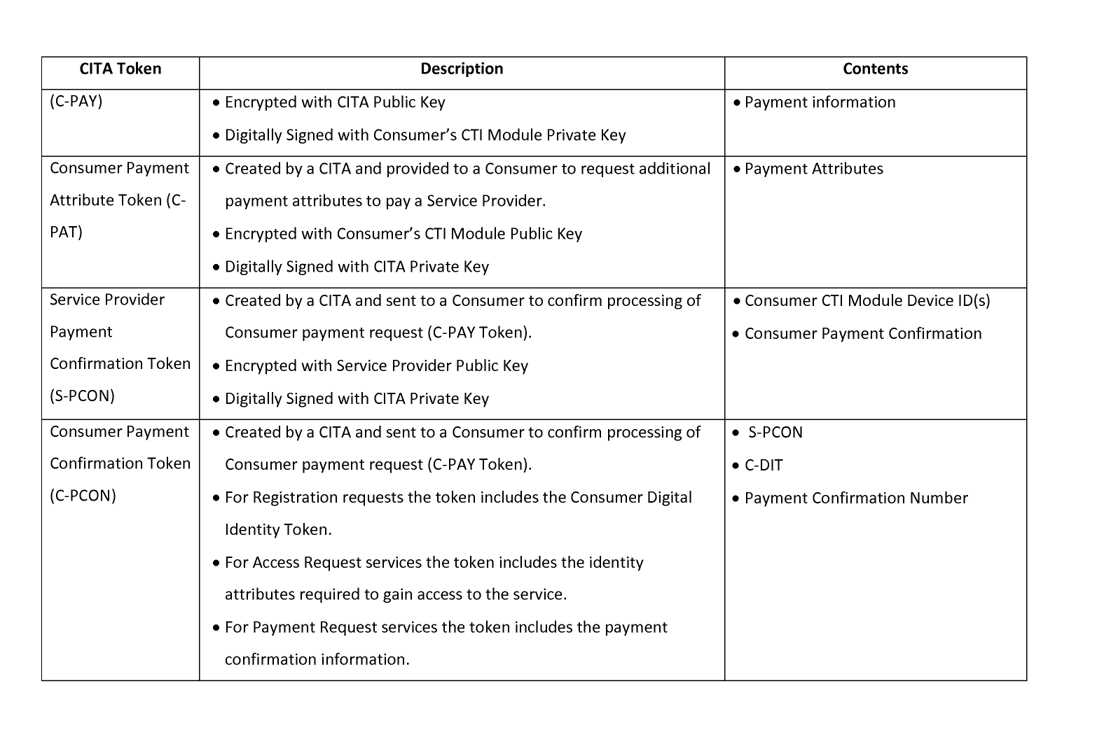

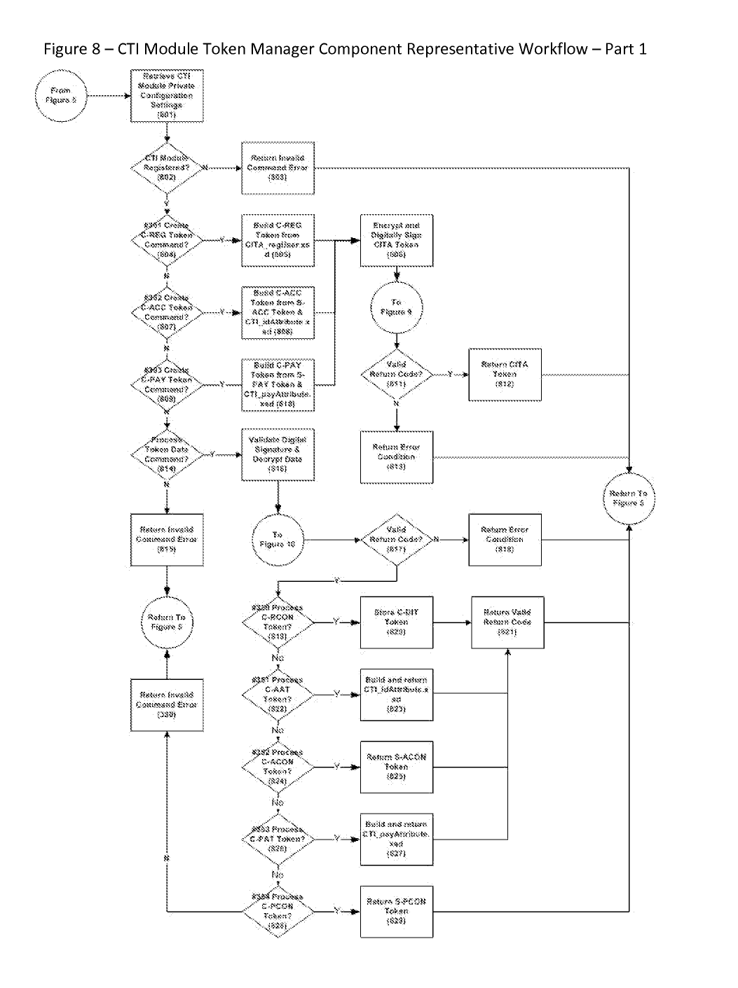

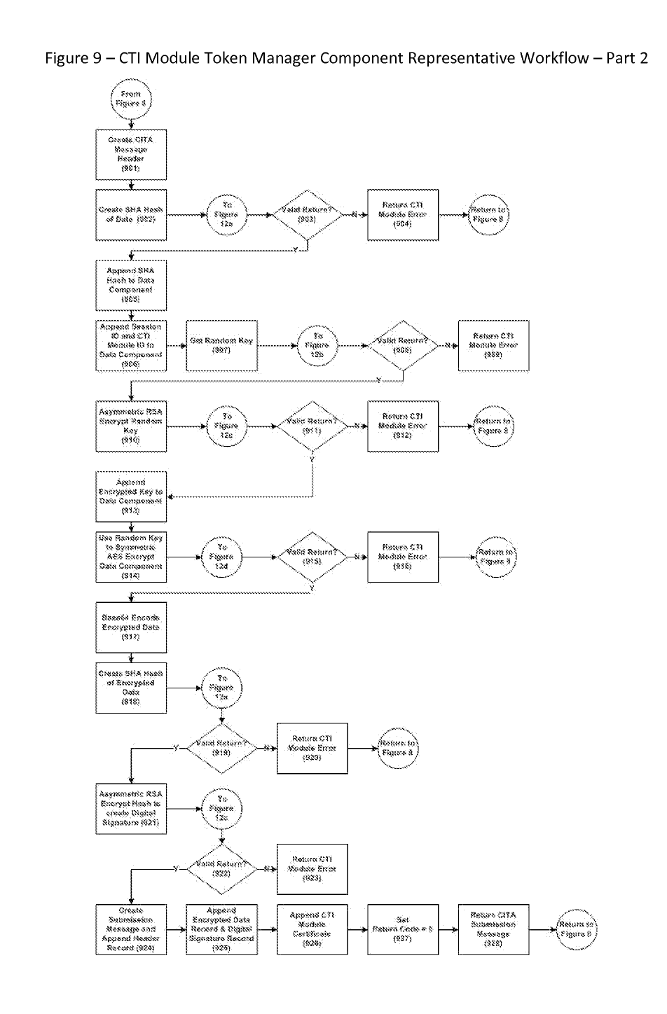

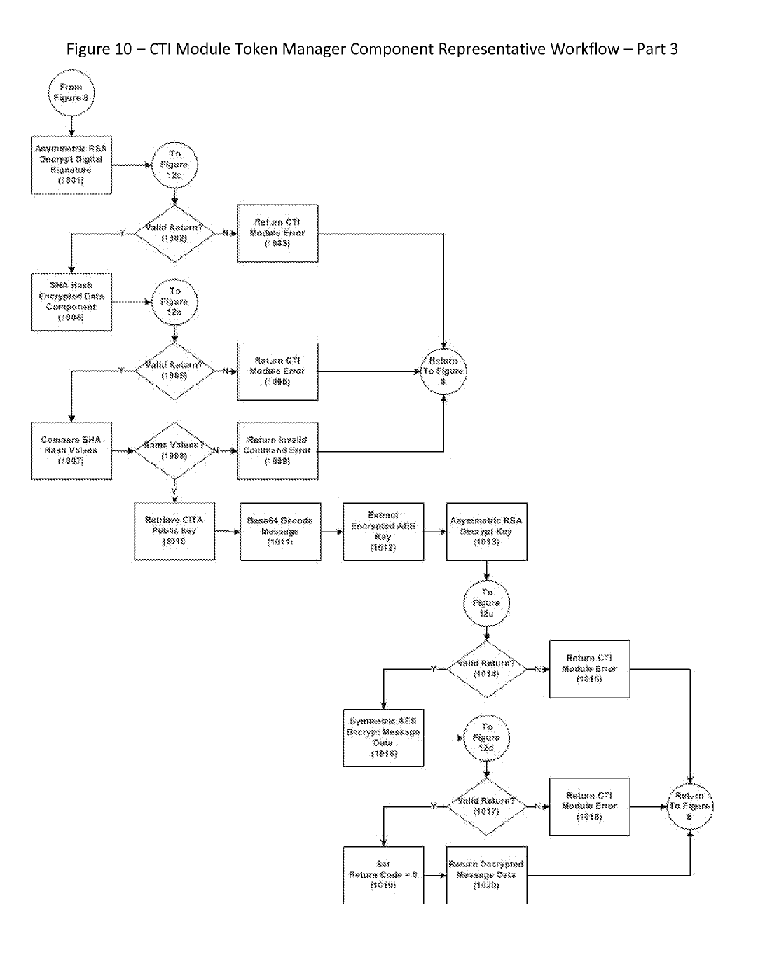

An example of a representative workflow processing logic for the Token Manger Component (TMC) is presented under FIG. 8, with supplemental workflows presented under FIG. 9 and FIG. 10 for clarity.

As depicted in FIG. 8, all CITA transactions are passed from the IGC to the TMC for processing. Upon receipt the TMC retrieves the private configuration settings (Step 801) and then verifies the CTI Module has been registered to the owner (Step 802). If the module has not been registered to the owner an error is returned (Step 803) to the IGC. If the module has been registered to the owner the TMC next checks if the submitted command is a request to create a CITA Consumer Registration (C-REG) Token (Step 804), which is used to register for CITA services. If this condition is true the TMC constructs the C-REG token using the information provided in the CITA_reqUser.xml data packet (step 805) and then constructs the CITA message by encrypting and digitally signing the packet (Step 806). Note: The building of the CITA message and the data encryption and digital signature operations are presented under FIG. 9 and described further below.

If the command was not a request to build a CITA C-REG Token the TMC next checks to see if the command is to build a CITA Consumer Access (C-ACC) Token (Step 807). This command is used when a consumer is requesting access to a service provider's service and the service provider has in turn provided the consumer with a Service Provide Access (S-ACC) Token. If this condition is true the TMC constructs the C-ACC token using the Service Provider Access (S-ACC) Token and the information provided in the CTI_idAttribute.xml data packet (Step 808) to construct the CITA message by encrypting and digitally signing the packet (Step 806). Note: The building of the CITA message and the data encryption and digital signature operations are presented under FIG. 9 and described further below.

If the command was not a request to build a CITA C-ACC Token the TMC next checks to see if the command is to build a CITA Consumer Payment (C-PAY) Token (Step 809). This command is used when a consumer is requesting access payment to a service provider for services provided and the service provider has in turn provided the consumer with a Service Provide Payment (S-PAY) Token. If this condition is true the TMC constructs the C-PAY token using the Service Provider Payment (S-PAY) Token and the information provided in the CTI_payAttribute.xml data packet (step 810) to construct the CITA message by encrypting and digitally signing the packet (Step 806). Note: The building of the CITA message and the data encryption and digital signature operations are presented under FIG. 9 and described further below. After the encrypted and digitally signed data packet is prepared the TMC validates a successful return code from the encryption and digital signing operations (Step 811). If the operation was successful the encrypted and digitally signed data packet is returned (Step 812) to the IGC. If an error was encountered an error response is returned (Step 813) to the IGC.

If the command was not to create a CITA Token the next check the TMC performs is to see if the command is to process a CITA Token (Step 814). If the command is not a request to process a CITA Token (i.e., 350>command <400) and error is returned (Step 815) to the IGC.

If the command was to process CITA Token data (Step 814) the TMC must validate the digital signature and decrypt the data contents of the CITA Token since all CITA data has been encrypted and digitally signed by the CITA (Step 816). Note: The digital signature validation and data decryption operations of the CITA message are presented under FIG. 10 and described further below.

Once this operation is completed the TMC next checks to see if any errors were encountered in verifying the CITA digital signature or decrypting the data content (Step 817). If an error was encountered the TMC returns an error condition (Step 818) to the IGC. If no errors were encountered the TMC checks to see if the command was to process a CITA Consumer Registration Confirmation (C-RCON) Token (Step 819). This command is used to process the response from a CITA registration request and to obtain the consumer's CITA assigned Consumer Digital Identity (C-DIT) Token. If this condition is true the TMC stores the extracted Consumer Digital Identity (C-DIT) Token to the CTI Module digital identity token storage repository and returns a valid return code (Step 821) to the IGC. If the command was not a request to process a CITA C-RCON Token the TMC next checks to see if the command is to process a CITA Consumer Access Attribute (C-AAT) Token (Step 822). This command supports the ability for the CITA to request additional identity attributes that may not be presently defined under the owner's CITA registry, but are required for gaining access to the requested service. If this condition is true the TMC uses the extracted C-AAT token data elements to build and return the CTI_idAttribute.xml data packet (Step 823) to the IGC. Thus, a third party application can use this information to notify the owner of the additional identity attributes required to gain access to the service. If the command was not a request to process a CITA C-AAT Token the TMC next checks to see if the command is to process a CITA Consumer Access Confirmation (C-ACON) Token (Step 824). This command is used to process the response from a CITA access request and to obtain the Service Provider's Access Confirmation (S-ACON) Token. If this condition is true the TMC returns the S-ACON token extracted from the C-ACON token (Step 825) to the IGC. If the command was not a request to process a CITA C-ACON Token the TMC next checks to see if the command is to process a CITA Consumer Payment Attribute (C-PAT) Token (Step 826). This command supports the ability for the CITA to request additional payment attributes that may not be presently defined under the owner's CITA registry (or the defined attributes are no longer valid, i.e., a credit card has expired), but are required for completing payment for the provided service. If this condition is true the TMC uses the extracted C-PAT token data elements to build and return the CTI_payAttribute.xml data packet (Step 827) to the IGC. Thus, a third party application can use this information to notify the owner of the additional payment attributes required to complete the payment request. If the command was not a request to process a CITA C-PAT Token the TMC next checks to see if the command is to process a CITA Consumer Payment Confirmation (C-PCON) Token (Step 828). This command is used to process the response from a CITA payment request and to obtain the Service Provider's Payment Confirmation (S-PCON) Token. If this condition is true the TMC returns the S-PCON token extracted from the C-PCON token (Step 829) to the IGC. For all other commands presented to the TMC an error condition is returned (Step 830).

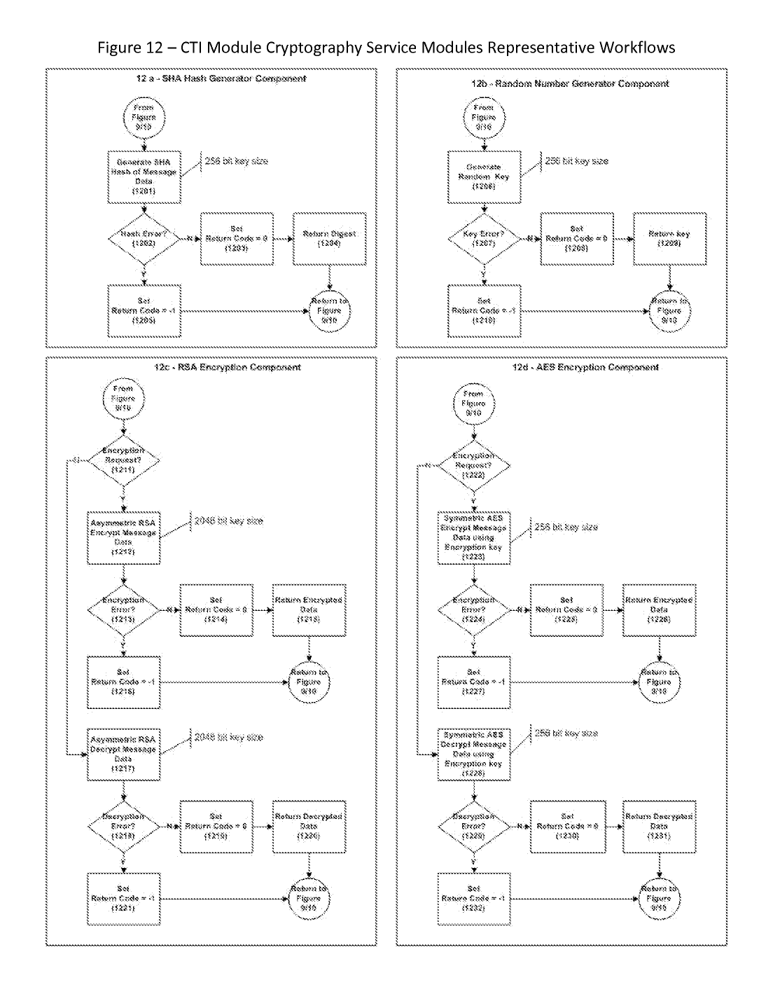

FIG. 9 presents the TMC operations for constructing a CITA message containing a CITA Token, which includes; building the message header (901), creating a hash of the registration data and appending this to the message content (902-905), appending the Session ID and the unique CTI Module Device ID to the message content (906), generating a random encryption key and using the key to encrypt the data (907-917), creating a digital signature of the record submission (918-923), and assembling the CITA Token message for submission (924-928). Note: Cryptographic operations presented under FIG. 9 are performed by the Cryptographic Services Module (CSM), as presented under FIG. 12, and described further below. By including the unique CTI Module Device ID within the encrypted data element the methodology provides a means to authenticate the device that the CITA Token originated from, as the encrypted data cannot be interpreted and the hash ensures the data has been unaltered.

FIG. 10 presents the TMC operations for processing a CITA message containing a CITA Token, which includes; validating the digital signature (Steps 1001-1009), decrypting the data component (Steps 1010-1019) and extracting and returning the transaction data elements from the CITA Token response (Step 1020). Note: Cryptographic operations presented under FIG. 10 are performed by the Cryptographic Services Module (CSM), as presented under FIG. 12, and described further below.

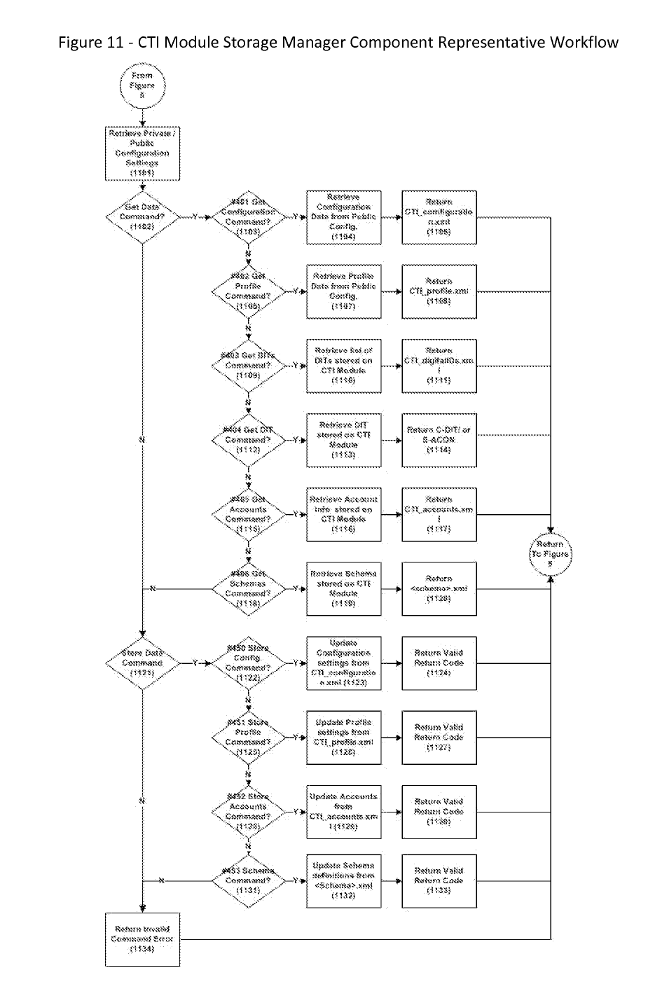

An example of a representative workflow processing logic for the Storage Manger Component (SMC) is presented under FIG. 11. The SMC is responsible for processing commands associated with retrieving and/or storing data elements within the secure storage repository of the CTI Module.

The first action performed by the SMC is to retrieve the private/public configurations settings (Step 1101) for the CTI Module. This action is taken to determine the current status for the owner's CITA registration status, as request to retrieve CITA data tokens from the secure storage repository would not be valid if the owner is not already registered with a CITA. As well, storing data elements in the storage repository may require the updating of private/public configuration settings, i.e., the owner has registered a profile on the module, the owner's configuration preferences have been updated, or a CITA Digital Identity Token (DIT) has been received to be stored on the module and the configuration settings for the CITA accounts requires updating.

After retrieving the private/public configuration settings the next action taken is to determine if the requested command is to “Get” data from the module (1102). If the request is to get data the SMC next determines what type of data has been requested in the command. If the request was for CTI Module configuration data (Step 1103) the CTI Module public configuration data is retrieved from the module's storage repository (Step 1104) and used to populate the CTI configuration.xml data packet (Step 1105), and returned to the IGC. If the request was for CTI Module owner profile data (Step 1106) the CTI Module owner profile data is retrieved from the module's storage repository (Step 1107) and used to populate the CTI_profile.xml data packet (Step 1108), and returned to the IGC. If the request was for a listing of all Digital Identity Tokens (DITs) stored on the CTI Module (Step 1109) the DIT list is assembled from DIT Index stored on the module's digital identity storage repository (Step 1110) and used to populate the CTI_digitallDs.xml data packet (Step 1111), and returned to the IGC. If the request was for a specific Digital Identity Token (DIT) stored on the CTI Module (Step 1112) the DIT is retrieved from the module's digital identity storage repository (Step 1113), and returned to the IGC (Step 1114). If the request was for account information stored on the CTI Module (Step 1115) the account information is retrieved from the module's storage repository (Step 1116) and used to populate the CTI_accounts.xml data packet (Step 1117), and returned to the IGC. If the request was for schema definitions stored on the CTI Module (Step 1118) the requested schema definition (.xsd file) is retrieved from the module's storage repository (Step 1119) and returned to the IGC (Step 1120).

If the command was a request to “store” data on the CTI Module (Step 1121) the SMC next determines what type of data has been requested to be stored in the command. If the request was to store configuration data (Step 1122) the data elements are extracted from the CTI_configuration.xml data packet and used to update the CTI Module public configuration settings stored in the module's storage repository (Step 1123) and a valid response is returned to the IGC (Step 1124). If the request was to store profile data (Step 1125) the data elements are extracted from the CTI_profile.xml data packet and used to update the CTI Module owner profile configuration settings stored in the module's storage repository (Step 1126) and a valid response is returned to the IGC (Step 1127). If the request was to store account data (Step 1128) the data elements are extracted from the CTI_accounts.xml data packet and used to update the CTI Module account information stored in the module's storage repository (Step 1129) and a valid response is returned to the IGC (Step 1130). If the request was to store schema definition data (Step 1131) the submitted .xsd file is used to update the corresponding schema definition on the CTI Module storage repository (Step 1132) and a valid response is returned to the IGC (Step 1133). For all other commands an error condition is returned (Step 1134) to the IGC.

An example of a representative workflow processing logic for the Cryptography Services Module is presented under FIG. 12. The Cryptography Services Module provides general cryptography services, to include SHA Hash operations, RSA Encryption/Decryption operations, AES Encryption/Decryption operations, and Random Number Generation operations. These services were referenced under FIG. 9 and FIG. 10 above. It is noted that while specific encryption algorithms and key sizes are identified under this implementation example the invention cited within is not limited to the cited algorithms or key sizes as the CTI Module can support various algorithms and key sizes depending upon the intended implementation requirements for any given system and/or application. As such, the examples cited within are not intended to limit the implementations of the invention and/or the claims specified under this invention, as various implementation approaches may be taken without contradicting and/or violating the spirit and scope of this invention.

The SHA Hash Generator Component (See FIG. 12a) receives the submitted message data from the TMC and generates a SHA Hash of the message data (Step 1201) to create a message digest. If no error was encountered during the operation (Step 1202) a successful return code is set (Step 1203) and the message digest is returned to the TMC (Step 1204). If an error was encountered during the hashing operation an error response is returned (Step 1205).

The Random Number Generator Component (See FIG. 12b) is responsible for generating a random Key, which is subsequently used to perform data encryption operations. This component generates a random Key (Step 1206) and then validates the operation was successful. If no error was encountered during the operation (Step 1207) a successful return code is set (Step 1208) and the random number is returned to the TMC (Step 1209). If an error was encountered during the random number generation operation an error response is returned (Step 1210).

The RSA Encryption Component (See FIG. 12c) is responsible for performing RSA Encryption and Decryption operations on a submitted message data element using the submitted encryption key. The first check performed by the component is to determine the operation requested. If an encryption operation was requested (Step 1211) the component performs an Asymmetric RSA encryption of the message data using the supplied encryption key (Step 1212). The component verifies no encryption errors were encountered (Step 1213) and if successful sets the return code to success (Step 1214) and returns the encrypted data (Step 1215). If an error was encountered a negative return code is returned (Step 1216). If a decryption operation was requested the component performs an Asymmetric RSA decryption of the message data using the supplied encryption key (Step 1217). The component verifies no decryption errors were encountered (Step 1218) and if successful sets the return code to success (Step 1219) and returns the decrypted data (Step 1220). If an error was encountered a negative return code is returned (Step 1221).

The AES Encryption Component (See FIG. 12d) is responsible for performing AES Encryption and Decryption operations on a submitted message data element using the submitted encryption key. The first check performed by the component is to determine the operation requested. If an encryption operation was requested (Step 1222) the component performs a Symmetric AES encryption of the message data using the supplied encryption key (Step 1223). The component verifies no encryption errors were encountered (Step 1224) and if successful sets the return code to success (Step 1225) and returns the encrypted data (Step 1226). If an error was encountered a negative return code is returned (Step 1227). If a decryption operation was requested the component performs a Symmetric AES decryption of the message data using the supplied encryption key (Step 1228). The component verifies no decryption errors were encountered (Step 1229) and if successful sets the return code to success (Step 1230) and returns the decrypted data (Step 1231). If an error was encountered a negative return code is returned (Step 1232).

What is claimed is:

1. A method and system incorporating PKI, Digital Signature, Data Hashing, Data Encryption, multi-modal biometric matching technology, and providing the ability to support secure storage and the processing of cyberspace user identity attributes and cyberspace digital identity tokens.

2. The System of claim 1, comprising a security module, a driver module, at least one computer program application, and an electronic device.

3. The Method of claim 1, wherein access to the security module requires an electronic device owner to first complete a registration process using the computer program application of claim 2.

4. The Method of claim 1, wherein the owner of the electronic device of claim 2 is required to authenticate their identity to the security module of claim 2 in order to gain access to data elements stored on the security module.

5. The Method of claim 1, wherein access to the security module of claim 2 is protected through multi-modal biometric identification methodologies.

6. The Method of claim 1, wherein the processing performed on the security module of claim 2 is defined through a session.

7. The Method of claim 1, wherein the security module of claim 2 utilizes PKI, digital signature, data hashing, and data encryption methodologies to support the establishment of mutually authenticated and secured communication links between two cyberspace parties, and the exchange of encrypted and digitally signed data packets.

8. The Electronic Device of claim 2, wherein said device can be any form of computing device with an operating system, CPU, memory, system bus, internet/intranet connectivity, and/or display, and may include a desktop PC, laptop PC, tablet PC, smart phone, or other iterations of electronic devices supporting electronic computing and communication mechanisms.

9. The Security Module of claim 2, wherein said module is implemented in hardware, software, or firmware, and said module can be incorporated into the electronic device of claim 2 as an internal component attached to the mother board, or as an external peripheral to said electronic device.

10. The Security Module of claim 2, wherein said module is comprised of; an Interface Gateway Module; a Transaction Processing Module; a Cryptography Service Module; a Versatile Memory Module; and a Persistent Memory Module, where said modules are interconnected through a system bus architecture.

11. The Interface Gateway Module of claim 10 wherein said module is further comprised of an interface Gateway Component, which controls all access to the security module of claim 2.

12. The Transaction Processing Module of claim 10 wherein said module is further comprised of a Biometric Matcher Component, a Token Manager Component, and a Storage Manager Component.

13. The Cryptography Service Module of claim 10 wherein said module supports data encryption, data hashing, digital signature, and random number generation operations, using configurable encryption algorithms and varying key sizes.

14. The Versatile Memory module of claim 10, wherein said module supports the storage of configuration data, attestation keys, digital certificates, biometric samples, owner information, and cyberspace user digital identity tokens.

15. The Persistent Memory Module of claim 10, wherein said module incorporates a unique Private/Public key pair and a unique Device ID, which is assigned to the module at time of manufacturing, securely stored on said module, and subsequently used for performing data encryption and digital signature operations performed on the security module of claim 2.

16. The System Bus Architecture of claim 10, wherein said architecture is comprised of the system bus on the electronic device of claim 2, coupled with the private system bus architecture of the security module of claim 2. Said private system bus architecture comprising a CTI Module Service Memory Bus, CTI Module Service Bus, CTI Module Cryptography Service Bus, and a CTI Module Private Memory Bus.

17. The Cyberspace User Identity attributes of claim 1, wherein said attributes may include names, phone numbers, addresses, email addresses, financial account information, medical account information, insurance account information, club membership information, retailer account information, travel document information, web site portal information, Cyberspace digital identity tokens, and any other information an electronic device owner may wish to securely store on the security module of claim 2.

18. The Cyberspace Digital Identity tokens of claim 17, wherein said tokens may be generated by a Cyberspace Identification Trust Authority (CITA) system, or any other system that establishes mutual trust between two cyberspace parties. Said tokens providing the ability to mutually authenticate the identity of two parties conducting a cyberspace transaction.

19. The Driver Module of claim 2, wherein said module supports the submission of commands against the security module of claim 2 and said security module supporting the ability to process said commands. Said commands at a minimum consisting of; Open Module, Close Module, Register Biometric, Authenticate Biometric, Match Biometric, Update Biometric, Create C-REG Token, Create C-ACC Token, Create C-PAY Token, Process C-RCON Token, Process C-AAT Token, Process C-ACON Token, Process C-PAT Token, Process C-PCON Token, Get Configuration, Get Profile, Get DITS, get DIT, Get Accounts, Get Schema Definition, Store Configuration, Store Profile, Store Accounts, and Store Schema Definition.

20. The Registration method of claim 3, wherein the owner of the electronic device uses the computer program application of claim 2 to capture one or more live biometric samples. The live biometric samples form a registration packet, which is submitted to the security module of claim 2 using the Register Biometric command of claim 19. The live biometric samples are enrolled to said security module and saved to the versatile memory module of claim 14. The enrolled biometric samples are herein after referred to as the biometric enrolment set.

21. The Identity Authentication method of claim 4, wherein initial access to the security module Of claim 2, or subsequent access when a session timeout event occurs, requires the device owner to use the computer program application of claim 2 to capture one or more live biometric samples corresponding to the biometric enrolment set of claim 20. These live biometric samples are matched against said biometric enrolment set using multi-modal biometric matching technology. If the presented live samples match the corresponding biometric enrolment set access to the security module is granted. If the presented live biometric samples do not match the corresponding biometric enrolment set access to the security module is denied.

22. The Session method of claim 6, wherein said session is defined by a unique Session ID and is initiated following the successful processing of an Open Command of claim 19 and completed following the successful processing of a Close Command of claim 19, or when an error condition is encountered.

23. The Session ID of claim 22 wherein said Session ID is required to be provided will all subsequent commands submitted during a given session and is validated to be the current Session ID or the submitted command returns an error. If a session is ended, via encountering an error or the session is closed via the Close Command of claim 19, the Session ID is cleared and the security module assumes a locked state and no additional commands will be processed until another successful Open Command is processed.

24. The Session Timeout method of claim 21, wherein commands processed by the security module of claim 2 are performed under the unique Session ID of claim 23, which lasts for a defined period of time, as defined by the Session Timeout value. If a command is presented to the security module when the current system time exceeds the session timeout value said Session Timeout event is raised. When this occurs the only command the security module will accept is a Register Biometric, Authenticate Biometric, or Match Biometric command, as defined under claim 16, which if processed successfully resets said session timeout value.

25. The Session Timeout value of claim 24, wherein said value is based upon the current time, plus the device owner's specified user profile setting for re-authentication time.

26. The Configuration Data of claim 14 wherein said configuration data is comprised of both Public configurations settings and Private configuration settings. Public configuration settings are available for retrieval and modification by the electronic device owner of claim 3, and enable said owner to custom configure the security features and usability of the security module of claim 2. Private Configuration settings can only be accessed by said security module components, as they control the internal processing logic and maintain the security and integrity of said module.

27. The Interface Gateway Component of claim 11, wherein said component supports attestation methodologies such that CITA system applications, or any other system applications that interface with said component and establish mutual trust between two cyberspace parties, can be guaranteed for authenticity.

28. The Biometric Matcher Component of claim 12, wherein said component utilizes CAPTCHA methodologies to dynamically define the types of biometric samples to be provided for performing a multi-modal biometric match operations. Said methodologies are designed to ensure fraudulent attempts to circumvent the biometric authentication capabilities of the security module of claim 2 are eliminated.

29. The Unique Device ID of claim 15, wherein said Device ID is included within the encrypted and digitally signed data packets of claim 7 and the Cyberspace Digital Identity Token (DIT) of claim 18. Comparing said Device ID between the decrypted value in the said data packet and the corresponding decrypted value in said DIT provides a means to authenticate the cyberspace transaction originated from the registered Electronic device and security module of claim 2.
